(19) United States
(12) Patent Application Publication
(10) Pub. No.: US 2026/0292034 A1
(43) Pub. Date: Sep. 24, 2026

(54) METHOD AND APPARATUS FOR NETWORK FUNCTION DISCOVERY

(71) Applicant: Telefonaktiebolaget LM Ericsson (publ), Stockholm (SE)

(72) Inventors: Yunjie LU, Shanghai (CN); Jesús Ángel DE GREGORIO RODRIGUEZ, Boadilla Del Monte, Madrid (ES); Qiong SONG, Shanghai (CN); Wu WANG, Shanghai (CN); Peng LI, Shanghai (CN)

(73) Assignee: Telefonaktiebolaget LM Ericsson (publ), Stockholm (SE)

(21) Appl. No.: 19/473,001

(22) PCT Filed: Apr. 3, 2024
(86) PCT No.: PCT/CN2024/085776

§ 371 Date: Oct. 6, 2025

(30) Foreign Application Priority Data
Apr. 6, 2023 (WO) PCT/CN2023/086595

(51) Int. Cl. H04L 67/51

(52) U.S. Cl. CPC H04L 67/51

(57) ABSTRACT

Embodiments of the present disclosure provide methods and apparatuses for NF discovery. A method performed by an NF may comprise sending a first NF discovery request comprising at least one query parameter to a first network repository function (NRF). The method may further comprise receiving a first NF discovery response from the first NRF. The first NF discovery response may comprise a search result and information indicating at least one ignored unsupported query parameter and/or at least one ignored supported query parameter in the at least one query parameter for the search result.

### TECHNICAL FIELD

The non-limiting and exemplary embodiments of the present disclosure generally relate to the technical field of communications, and specifically to method and apparatus for network function (NF) discovery.

### BACKGROUND

This section introduces aspects that may facilitate a better understanding of the disclosure. Accordingly, the statements of this section are to be read in this light and are not to be understood as admissions about what is in the prior art or what is not in the prior art.

In a network such as fifth generation core network (5GC), an NF service consumer may discover an NF producer candidate via Network Repository Function (NRF). To do so, the NF consumer may send a discovery request to the NRF. The discovery request may include a set of discovery factors, i.e. query parameters, e.g. to filter the target NF producer candidate(s) like NF type, serving area, etc. or to provide self-information to allow the NRF to validate the NF service consumer's accessibility to the target NF producers.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

When the NRF receives the discovery request comprising an unsupported query parameter, the NRF may select to reject the discovery request or return a search/discovery result by ignoring the unsupported query parameter. However either way has obvious drawbacks.

When the NRF ignores the unsupported query parameter(s) and provides the NF producer candidate(s) by using the rest query parameter(s), the search/discovery result may not be usable by the NF consumer/NF service consumer if the ignored query parameter(s) is essential for the service logic, e.g. the serving Data Network Name (DNN) for a session management function (SMF). It may be not predictable whether the unsupported query parameter(s) is critical for the service logic or not, and actually it shouldn't be always be aware by the NRF as a repository function.

When the NRF simply rejects the discovery request, then the NF consumer may need to know which query parameter(s) is supported by the NRF beforehand to avoid the discovery failure. In a deployment, it may be possible to align the supported query parameter(s) by configuration in NF consumers. Such configuration may be already a challenge in a network as any NF can be potentially an NF consumer. Furthermore, the configuration in NF consumers may become totally unmanageable for inter-Public Land Mobile Network (PLMN) scenarios, where the NF consumer or visited NRF (vNRF) or home NRF (hNRF) needs to talk with NRFs in a huge number of partner PLMNs and the huge number of NRFs may all have different supported query parameters.

There should be a mechanism to help the NRF to understand how to handle the unsupported query parameter(s) and/or help the NF consumer to understand how the discovery result is generated.

To overcome or mitigate at least one of above mentioned problems or other problems, the embodiments of the present disclosure propose an improved solution for NF discovery.

In a first aspect of the disclosure, there is provided a method performed by a network function (NF). The method may comprise sending a first NF discovery request comprising at least one query parameter to a first network repository function (NRF). The method may further comprise receiving a first NF discovery response from the first NRF. The first NF discovery response may comprise a search result and information indicating at least one ignored unsupported query parameter and/or at least one ignored supported query parameter in the at least one query parameter for the search result.

In an embodiment, the method may further comprise obtaining information regarding one or more query parameters supported by the first NRF. The method may further comprise determining one or more query parameters unsupported by the first NRF. The at least one query parameter may include at least one of the one or more query parameters supported by the first NRF and exclude the one or more query parameters unsupported by the first NRF.

In an embodiment, the obtaining information regarding one or more query parameters supported by the first NRF may comprise sending a first bootstrapping request or a second NF discovery request to the first NRF and receiving a first bootstrapping response or a second NF discovery response comprising the information regarding the one or more query parameters supported by the first NRF from the first NRF.

In an embodiment, the method may further comprise obtaining information regarding one or more query parameters supported by a second NRF.

In an embodiment, the method may further comprise determining one or more query parameters unsupported by the second NRF.

In an embodiment, when the first NF discovery request includes a network identity of the second NRF, the at least one query parameter may include at least one of the one or more query parameters supported by the second NRF and exclude the one or more query parameters unsupported by the second NRF.

In an embodiment, the obtaining information regarding one or more query parameters supported by the second NRF may comprise sending a second bootstrapping request or a third NF discovery request comprising a network identity of the second NRF to the first NRF and receiving a second bootstrapping response or a third NF discovery response comprising the information regarding the one or more query parameters supported by the second NRF from the first NRF.

In an embodiment, the first NRF may comprise a visited NRF and the second NRF may comprise a home NRF.

In an embodiment, the first NRF may comprise a home NRF and the second NRF may comprise a visited NRF.

In an embodiment, the method may further comprise determining whether the search result is useful or not based on the at least one ignored unsupported query parameters and/or the at least one ignored supported query parameter.

In an embodiment, the first NF discovery request may further comprise first information indicating whether a query parameter in the at least one query parameter is critical to a service logic or not.

In an embodiment, the first NF discovery response may comprise at least one of a search result generated by ignoring at least non-critical unsupported query parameter and/or at least one non-critical supported query parameter in the at least one query parameter, rejection information and cause information indicating a critical query parameter in the at least one query parameter is not supported, or redirection information when a critical query parameter in the at least one query parameter is not supported.

In an embodiment, the first information may comprise at least one of a new query parameter including a list of at least one critical query parameter's name, a Hyper Text Transfer Protocol (HTTP) header including a list of at least one critical query parameter's name, or a pattern or extension directly on a query parameter name to indicate a criticality.

In a second aspect of the disclosure, there is provided a method performed by a first NRF. The method may comprise receiving a first NF discovery request comprising at least one query parameter from an NF. The method may further comprise sending a first NF discovery response to the NF. The first NF discovery response may comprise a search result and information indicating at least one ignored unsupported query parameter and/or at least one ignored supported query parameter in the at least one query parameter for the search result.

In an embodiment, the at least one query parameter may include at least one of one or more query parameters supported by the first NRF and exclude one or more query parameters unsupported by the first NRF.

In an embodiment, the method may further comprise receiving a first bootstrapping request or a second NF discovery request from the NF. The method may further comprise sending a first bootstrapping response or a second NF discovery response comprising information regarding the one or more query parameters supported by the first NRF to the NF.

In an embodiment, when the first NF discovery request includes a network identity of a second NRF, the at least one query parameter may include at least one of one or more query parameters supported by a second NRF and exclude one or more query parameters unsupported by the second NRF.

In an embodiment, the method may further comprise receiving a second bootstrapping request or a third NF discovery request comprising a network identity of the second NRF from the NF. The method may further comprise sending a third bootstrapping request or a fourth NF discovery request to the second NRF. The method may further comprise receiving a third bootstrapping response or a fourth NF discovery response comprising information regarding the one or more query parameters supported by the second NRF from the second NRF. The method may further comprise sending a second bootstrapping response or a third NF discovery response comprising the information regarding the one or more query parameters supported by the second NRF to the NF.

In an embodiment, the first NRF may comprise a visited NRF and the second NRF may comprise a home NRF.

In an embodiment, the first NRF may comprise a home NRF and the second NRF may comprise a visited NRF.

In an embodiment, the first NF discovery request may further comprise first information indicating whether a query parameter in the at least one query parameter is critical to a service logic or not.

In an embodiment, the first NF discovery response may comprise a search result generated by ignoring at least non-critical unsupported query parameter and/or at least one non-critical supported query parameter in the at least one query parameter, or rejection information and cause information indicating a critical query parameter in the at least one query parameter is not supported, or redirection information when a critical query parameter in the at least one query parameter is not supported.

In an embodiment, the first information may comprise at least one of a new query parameter including a list of at least one critical query parameter's name, an HTTP header including a list of at least one critical query parameter's name, or a pattern or extension directly on a query parameter name to indicate a criticality.

In an embodiment, when the first NF discovery request includes a network identity of a second NRF, the method may further comprise sending a fifth NF discovery request comprising the at least one query parameter to the second NRF. The method may further comprise receiving a fifth NF discovery response from the second NRF.

In an embodiment, the fifth NF discovery response may comprise a search result and information indicating at least one ignored unsupported query parameter and/or at least one ignored supported query parameter in the at least one query parameter for the search result.

In an embodiment, the fifth NF discovery request may further comprise first information indicating whether a query parameter in the at least one query parameter is critical to a service logic or not.

In an embodiment, the fifth NF discovery response may comprise at least one of a search result generated by ignoring at least non-critical unsupported query parameter and/or at least one non-critical supported query parameter in the at least one query parameter, rejection information and cause information indicating a critical query parameter in the at least one query parameter is not supported, or redirection information when a critical query parameter in the at least one query parameter is not supported.

In an embodiment, when the first NF discovery request excludes a network identity of a second NRF, the method may further comprise at least one of determining a search result by ignoring at least one non-critical unsupported query parameter and/or at least one non-critical supported query parameter in the at least one query parameter, or determining whether to reject or accept the first NF discovery request based on a criticality of an unsupported query parameter in the at least one query parameter, or determining redirection information when a critical query parameter in the at least one query parameter is not supported.

In a third aspect of the disclosure, there is provided a method performed by a second NRF. The method may comprise receiving a fifth NF discovery request comprising at least one query parameter from a first NRF. The method may further comprise sending a fifth NF discovery response to the first NRF. The method may further comprise determining a search result by ignoring at least one non-critical unsupported query parameter and/or at least one non-critical supported query parameter in the at least one query parameter.

In an embodiment, the at least one query parameter may include at least one of one or more query parameters supported by the second NRF and exclude one or more query parameters unsupported by the second NRF.

In an embodiment, the method may further comprise receiving a third bootstrapping request or a fourth NF discovery request from the first NRF. The method may further comprise sending a third bootstrapping response or a fourth NF discovery response comprising information regarding the one or more query parameters supported by the second NRF to the first NRF.

In an embodiment, the first NRF may comprise a visited NRF and the second NRF may comprise a home NRF.

In an embodiment, the first NRF may comprise a home NRF and the second NRF may comprise a visited NRF.

In an embodiment, the fifth NF discovery response may comprise a search result and information indicating at least one ignored unsupported query parameter and/or at least one ignored supported query parameter in the at least one query parameter for the search result.

In an embodiment, the fifth NF discovery request may further comprise first information indicating whether a query parameter in the at least one query parameter is critical to a service logic or not.

In an embodiment, the fifth NF discovery response may comprise at least one of a search result generated by ignoring at least non-critical unsupported query parameter and/or at least one non-critical supported query parameter in the at least one query parameter, rejection information and cause information indicating a critical query parameter in the at least one query parameter is not supported, or redirection information when a critical query parameter in the at least one query parameter is not supported.

In an embodiment, the method may further comprise at least one non-critical supported query parameter in the at least one query parameter, or determining whether to reject or accept the fifth NF discovery request based on a criticality of an unsupported query parameter in the at least one query parameter, or determining redirection information when a critical query parameter in the at least one query parameter is not supported.

In a fourth aspect of the disclosure, there is provided an NF. The NF may comprise a processor and a memory coupled to the processor. Said memory contains instructions executable by said processor. Said NF may be operative to send a first NF discovery request comprising at least one query parameter to a first network repository function (NRF). Said NF may be further operative to receive a first NF discovery response from the first NRF. The first NF discovery response may comprise a search result and information indicating at least one ignored unsupported query parameter and/or at least one ignored supported query parameter in the at least one query parameter for the search result.

In a fifth aspect of the disclosure, there is provided a first NRF. The first may comprise a processor and a memory coupled to the processor. Said memory contains instructions executable by said processor. Said first NRF is operative to receive a first NF discovery request comprising at least one query parameter from an NF. Said first NRF is further operative to send a first NF discovery response to the NF. The first NF discovery response may comprise a search result and information indicating at least one ignored unsupported query parameter and/or at least one ignored supported query parameter in the at least one query parameter for the search result.

In a sixth aspect of the disclosure, there is provided a second NRF. The second NRF may comprise a processor and a memory coupled to the processor. Said memory contains instructions executable by said processor. Said second NRF is operative to receive a fifth NF discovery request comprising at least one query parameter from a first NRF. Said second NRF is further operative to send a fifth NF discovery response to the first NRF. Said second NRF is operative to determine a search result by ignoring at least one non-critical unsupported query parameter and/or at least one non-critical supported query parameter in the at least one query parameter.

In a seventh aspect of the disclosure, there is provided an NF. The NF may comprise a first sending module configured to send a first NF discovery request comprising at least one query parameter to a first network repository function (NRF). The NF may comprise a first receiving module configured to receive a first NF discovery response from the first NRF. The first NF discovery response may comprise a search result and information indicating at least one ignored unsupported query parameter and/or at least one ignored supported query parameter in the at least one query parameter for the search result.

In an embodiment, the NF may further comprise a first obtaining module configured to obtain information regarding one or more query parameters supported by the first NRF.

In an embodiment, the NF may further comprise a first determining module configured to determine one or more query parameters unsupported by the first NRF. The at least one query parameter may include at least one of the one or more query parameters supported by the first NRF and exclude the one or more query parameters unsupported by the first NRF.

In an embodiment, the NF may further comprise a second obtaining module configured to obtain information regarding one or more query parameters supported by a second NRF.

In an embodiment, the NF may further comprise a second determining module configured to determine one or more query parameters unsupported by the second NRF. When the first NF discovery request includes a network identity of the second NRF, the at least one query parameter may include at least one of the one or more query parameters supported by the second NRF and excludes the one or more query parameters unsupported by the second NRF.

In an embodiment, the NF may further comprise a third determining module configured to determine whether the search result is useful or not based on the at least one ignored unsupported query parameters and/or the at least one ignored supported query parameter.

In an eighth aspect of the disclosure, there is provided a first NRF. The first NRF may comprise a first receiving module configured to receive a first NF discovery request comprising at least one query parameter from an NF. The first NRF may further comprise a first sending module configured to send a first NF discovery response to the NF. The first NF discovery response may comprise a search result and information indicating at least one ignored unsupported query parameter and/or at least one ignored supported query parameter in the at least one query parameter for the search result.

In an embodiment, the first NRF may comprise a second receiving module configured to receive a first bootstrapping request or a second NF discovery request from the NF.

In an embodiment, the first NRF may further comprise a second sending module configured to send a first bootstrapping response or a second NF discovery response comprising information regarding the one or more query parameters supported by the first NRF to the NF.

In an embodiment, the first NRF may further comprise a third receiving module configured to receive a second bootstrapping request or a third NF discovery request comprising a network identity of the second NRF from the NF.

In an embodiment, the first NRF may further comprise a third sending module configured to send a third bootstrapping request or a fourth NF discovery request to the second NRF.

In an embodiment, the first NRF may further comprise a fourth receiving module configured to receive a third bootstrapping response or a fourth NF discovery response comprising information regarding the one or more query parameters supported by the second NRF from the second NRF.

In an embodiment, the first NRF may further comprise a fourth sending module configured to send a second bootstrapping response or a third NF discovery response comprising the information regarding the one or more query parameters supported by the second NRF to the NF.

In an embodiment, when the first NF discovery request includes a network identity of a second NRF, the first NRF may further comprise a fifth sending module configured to send a fifth NF discovery request comprising the at least one query parameter to the second NRF. The first NRF may further comprise a fifth receiving module configured to receive a fifth NF discovery response from the second NRF.

In an embodiment, when the first NF discovery request excludes a network identity of a second NRF, the first NRF may further comprise a first determining module configured to determine a search result by ignoring at least one non-critical unsupported query parameter and/or at least one non-critical supported query parameter in the at least one query parameter. The first NRF may further comprise a second determining module configured to determine whether to reject or accept the first NF discovery request based on a criticality of an unsupported query parameter in the at least one query parameter. The first NRF may further comprise a first determining module configured to determine redirection information when a critical query parameter in the at least one query parameter is not supported.

In a ninth aspect of the disclosure, there is provided a second NRF. The second NRF may comprise a first receiving module configured to receive a fifth NF discovery request comprising at least one query parameter from a first NRF. The second NRF may further comprise a first sending module configured to send a fifth NF discovery response to the first NRF. The second NRF may further comprise a first determining module configured to determine a search result by ignoring at least one non-critical unsupported query parameter and/or at least one non-critical supported query parameter in the at least one query parameter.

In an embodiment, the second NRF may further comprise a second receiving module configured to receive a third bootstrapping request or a fourth NF discovery request from the first NRF. The second NRF may further comprise a second sending module configured to send a third bootstrapping response or a fourth NF discovery response comprising information regarding the one or more query parameters supported by the second NRF to the first NRF.

In an embodiment, the second NRF may further comprise a second determining module configured to determine whether to reject or accept the fifth NF discovery request based on a criticality of an unsupported query parameter in the at least one query parameter.

In an embodiment, the second NRF may further comprise a third determining module configured to determine redirection information when a critical query parameter in the at least one query parameter is not supported.

In a tenth aspect of the disclosure, there is provided a computer-readable storage medium storing instructions which when executed by at least one processor, cause the at least one processor to perform any of the methods according to the first, second or third aspects of the disclosure.

In an eleventh aspect of the disclosure, there is provided a computer program product, comprising instructions which, when executed on at least one processor, cause the at least one processor to perform any of the methods according to the first, second or third aspects of the disclosure.

Many advantages may be achieved by applying the proposed solution according to embodiments of the present disclosure. In some embodiments herein, it can provide a coordinated way for NRF and NF consumer to perform NF discovery. In some embodiments herein, it can remove ambiguity on the behavior of NRF handling the request and NF consumer handling the search result when query parameters provided by NF consumer may not be supported by NRF. In some embodiments herein, it can avoid network traffic waste and avoid negative KPI due to rejection on service requests. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a schematically shows a high level architecture in the fifth generation network according to an embodiment of the present disclosure;

FIG. 1b schematically shows the 5G system roaming architecture in the case of home routed scenario with service-based interfaces within the control plane according to an embodiment of the present disclosure;

FIG. 1c schematically shows NRF roaming architecture in reference point representation according to an embodiment of the present disclosure;

FIG. 1d shows a flowchart of service discovery in the same PLMN;

FIG. 1e shows a flowchart of service discovery in the different PLMN;

FIG. 2a shows a flowchart of a method according to an embodiment of the present disclosure;

FIG. 2b shows a flowchart of a method according to another embodiment of the present disclosure;

FIG. 2c shows a flowchart of a method according to another embodiment of the present disclosure;

FIG. 2d shows a flowchart of a method according to another embodiment of the present disclosure;

FIG. 2e shows a flowchart of a method according to another embodiment of the present disclosure;

FIG. 2f shows a flowchart of a method according to another embodiment of the present disclosure;

FIG. 2g shows a flowchart of a method according to another embodiment of the present disclosure;

FIG. 3a shows a flowchart of a method according to another embodiment of the present disclosure;

FIG. 3b shows a flowchart of a method according to another embodiment of the present disclosure;

FIG. 3c shows a flowchart of a method according to another embodiment of the present disclosure;

FIG. 3d shows a flowchart of a method according to another embodiment of the present disclosure;

FIG. 3e shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 4c shows a flowchart of a method according to another embodiment of the present disclosure;

FIG. 5a shows a flowchart of solution-1.1 according to an embodiment of the present disclosure;

FIG. 5b shows a flowchart of solution-1.2 according to an embodiment of the present disclosure;

FIG. 6 shows a flowchart of solution 2 according to an embodiment of the present disclosure;

FIG. 7a shows a flowchart of solution 3 according to another embodiment of the present disclosure;

FIG. 7b shows a flowchart of solution 3 according to another embodiment of the present disclosure;

FIG. 7c shows a flowchart of solution 3 according to another embodiment of the present disclosure;

FIG. 8a is a block diagram showing an apparatus suitable for practicing some embodiments of the disclosure;

FIG. 8b is a block diagram showing an NF according to an embodiment of the disclosure;

FIG. 8c is a block diagram showing a first NRF according to an embodiment of the disclosure;

FIG. 8d is a block diagram showing a second NRF according to an embodiment of the disclosure;

FIG. 9 shows an example of a communication system according to an embodiment of the disclosure;

FIG. 10 shows a UE in accordance with some embodiments;

FIG. 11 shows a network node in accordance with some embodiments;

FIG. 12 is a block diagram of a host according to an embodiment of the disclosure;

FIG. 13 is a block diagram illustrating a virtualization environment in which functions implemented by some embodiments may be virtualized; and

FIG. 14 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” or “network function” refers to any suitable function which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

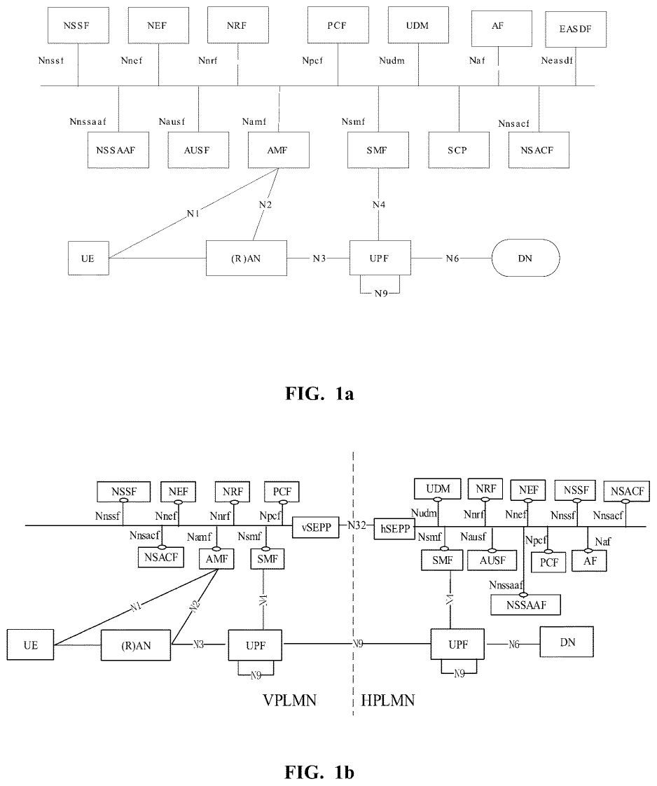

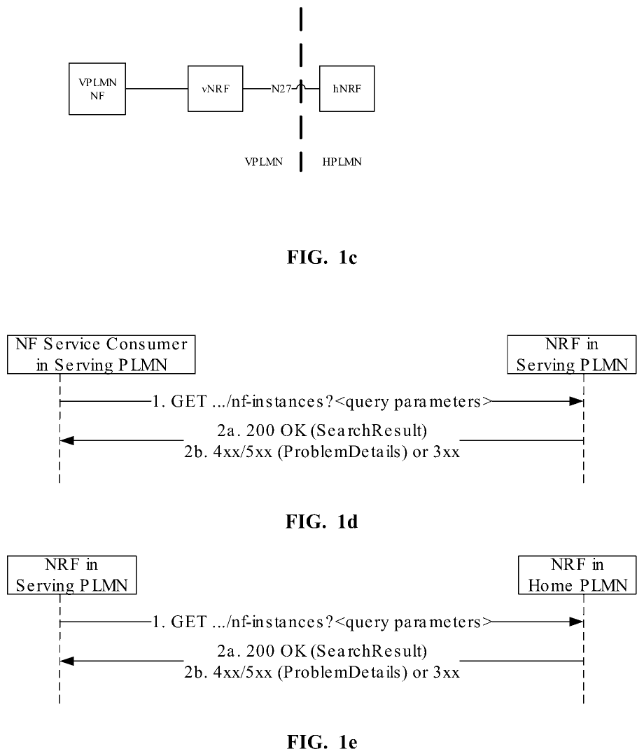

Although the subject matter described herein may be implemented in any appropriate type of system using any suitable components, the embodiments disclosed herein are described in relation to a communication system complied with the exemplary system architecture illustrated in FIG. 1a-1c. For simplicity, the system architectures of FIG. 1a-1c only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

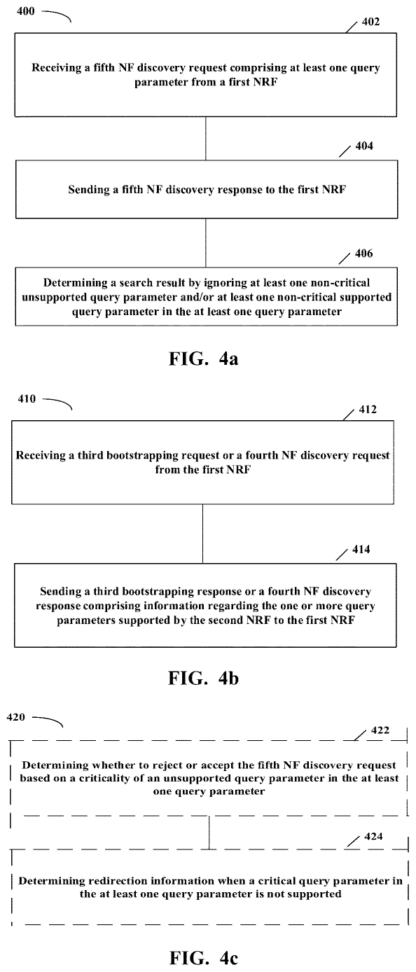

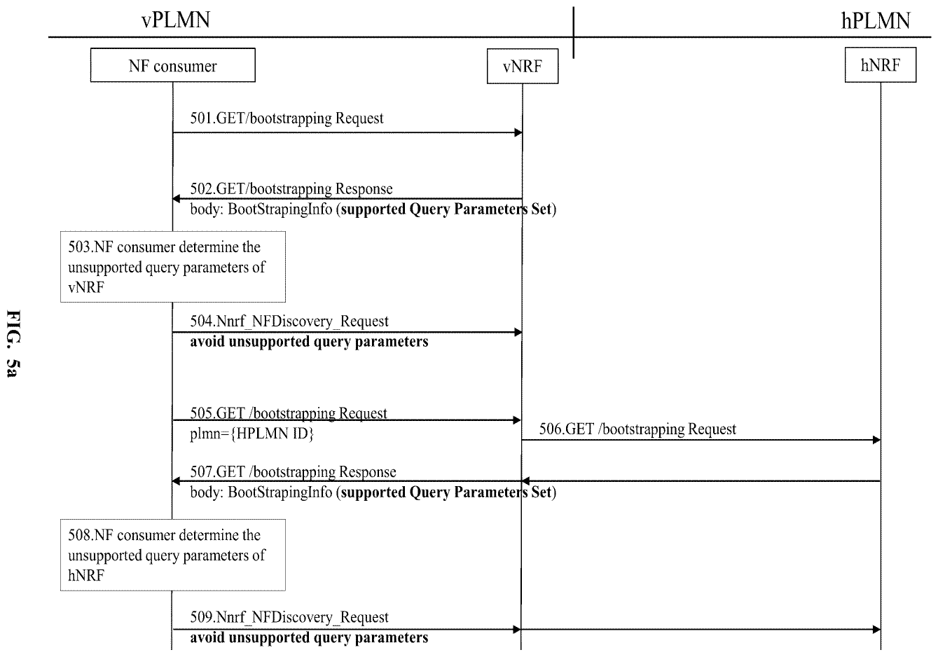

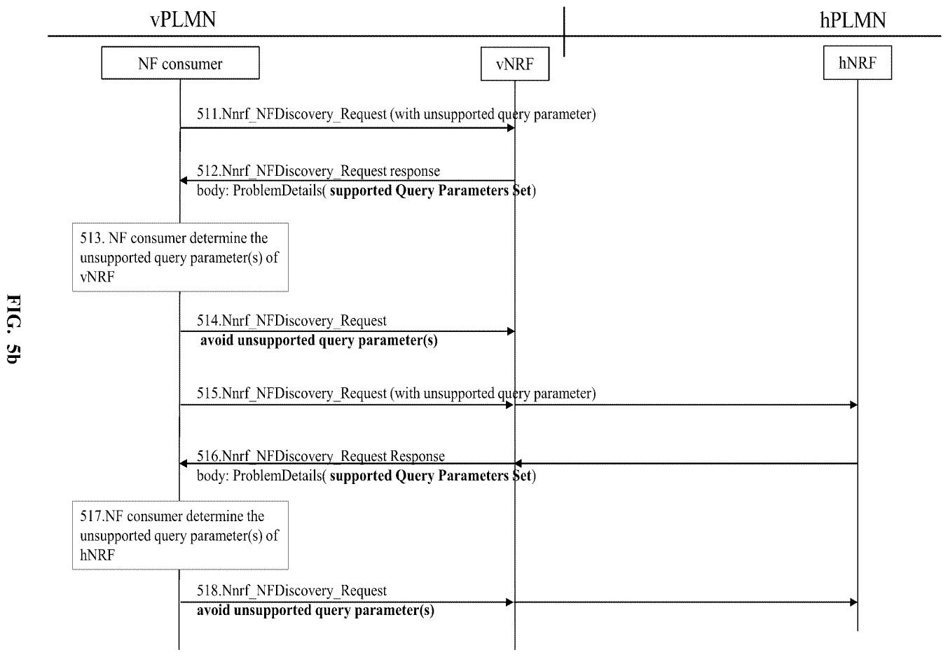

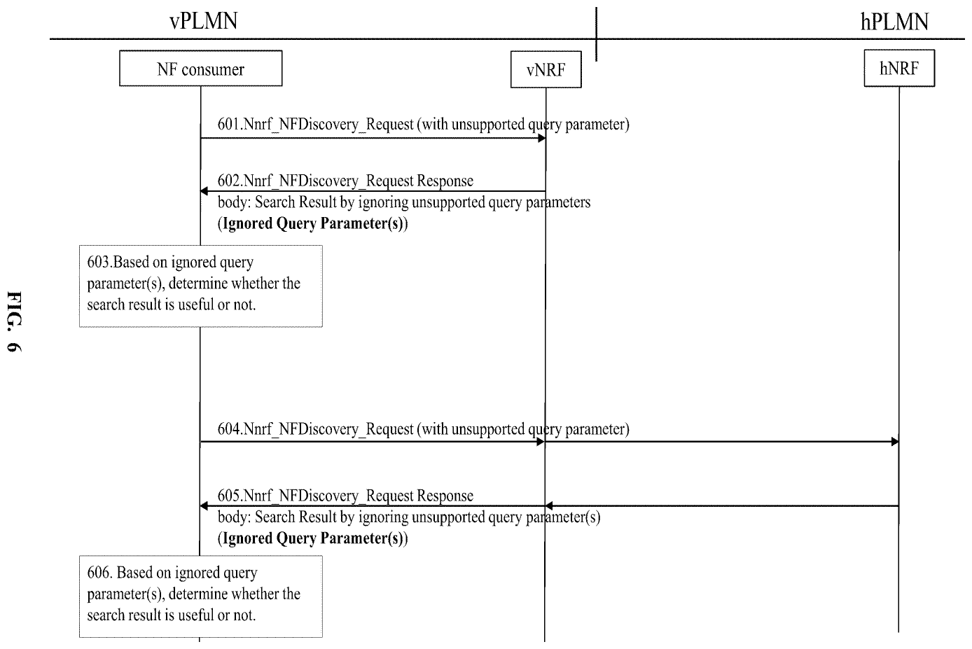

FIG. 1a schematically shows a high level architecture in the fifth generation network according to an embodiment of the present disclosure. The architecture of FIG. 1a is same as FIG. 4.2.3-1 of 3GPP TS 23.501 V18.0.0, the disclosure of which is incorporated by reference herein in its entirety. The system architecture of FIG. 1a may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), Edge Application Server Discovery Function (EASDF), etc.

In accordance with an exemplary embodiment, the UE can establish a signaling connection with the AMF over the reference point N1, as illustrated in FIG. 1a. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 1a, the exemplary system architecture also contains the service-based interfaces such as Nnrf, Nnef, Nausf, Nudm, Npcf, Namf, Nnsacf, Neasdf and Nsmf exhibited by NFs such as the NRF, the NEF, the AUSF, the UDM, the PCF, the AMF, the NSACF, the EASDF and the SMF. In addition, FIG. 1a also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

FIG. 1b schematically shows the 5G system roaming architecture in the case of home routed scenario with service-based interfaces within the control plane according to an embodiment of the present disclosure. The architecture of FIG. 1b is same as FIG. 4.2.4-3 of 3GPP TS 23.501 V18.0.0.

An SCP can be used for indirect communication between NFs and NF services within the VPLMN (visited PLMN), within the HPLMN (home PLMN), or in within both VPLMN and HPLMN. For simplicity, the SCP is not shown in the roaming architecture.

The Security Edge Protection Proxy (SEPP) is a non-transparent proxy and supports the following functionality:

### Message Filtering and Policing on Inter-PLMN Control Plane Interfaces.

The SEPP protects the connection between Service Consumers and Service Producers from a security perspective, i.e. the SEPP does not duplicate the Service Authorization applied by the Service Producers as specified in clause 7.1.4 of 3GPP TS 23.501 V18.0.0.

### Topology Hiding.

Detailed functionality of SEPP, related flows and the N32 reference point, are specified in 3GPP TS 33.501 V18.1.0, the disclosure of which is incorporated by reference herein in its entirety.

FIG. 1c schematically shows NRF roaming architecture in reference point representation according to an embodiment of the present disclosure. The architecture of FIG. 1c is same as FIG. 4.2.4-7 of 3GPP TS 23.501 V18.0.0.

For the roaming scenarios described above each PLMN implements proxy functionality to secure interconnection and hide topology on the inter-PLMN interfaces.

For the sake of clarity, SEPPs on both sides of PLMN borders are not depicted in FIG. 1c.

The 5G System Architecture contains the following reference points:

N1: Reference point between the UE and the AMF.

N2: Reference point between the (R)AN and the AMF.

N3: Reference point between the (R)AN and the UPF.

N4: Reference point between the SMF and the UPF.

N6: Reference point between the UPF and a Data Network.

N9: Reference point between two UPFs.

N27: Reference point between NRF in the visited network and the NRF in the home network.

N32: Reference point between a SEPP in one PLMN or SNPN and a SEPP in another PLMN or SNPN; or between a SEPP in a SNPN (Standalone Non-Public Network) and a SEPP in a CH (Credentials Holder)/DCS (Conditional Handover), where the CH/DCS contains a UDM/AUSF.

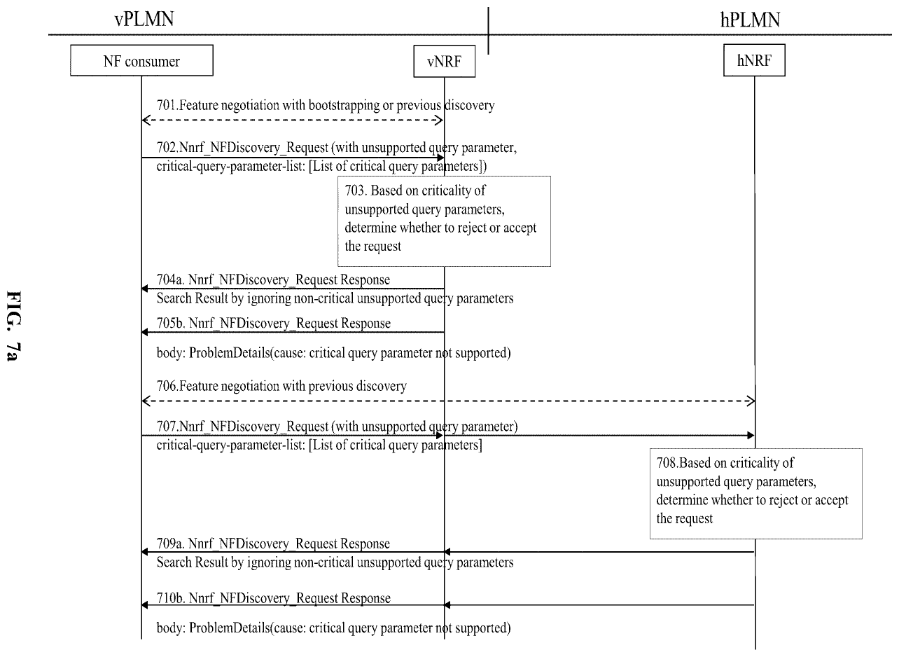

FIG. 1d shows a flowchart of service discovery in the same PLMN, which is same as FIG. 5.3.2.2.2-1 of 3GPP 29.510 V18.2.0, the disclosure of which is incorporated by reference herein in its entirety.

Clause 5.3.2.2.2 of 3GPP 29.510 V18.2.0 describes the steps of FIG. 1d as following.

This service operation is executed by querying the “nf-instances” resource. The request is sent to an NRF in the same PLMN of the NF Service Consumer.

1. The NF Service Consumer shall send an HTTP GET request to the resource URI “nf-instances” collection resource. The input filter criteria for the discovery request shall be included in query parameters.

An SCP may request to discover the complete profile of NF instances (including, e.g. the authorization attributes) matching the query parameters. Upon receiving such a request, the NRF shall verify that the requesting entity is authorized to discover the complete profile of NF instances, based on local policies or the receipt of an access token granting such permission. If the requesting entity is not authorized to do so, the NRF shall reject the request or handle it as a service discovery request without access to the complete profile.

2a. On success, “200 OK” shall be returned. The response body shall contain a validity period, during which the search result can be cached by the NF Service Consumer, and an array of NF Profile objects, and/or a map of NFInstanceInfo objects of NF instances (if the NF service consumer indicated support of the Enh-NF-Discovery feature in the request) that satisfy the search filter criteria (e.g., all NF Instances offering a certain NF Service name in REGISTERED status, or empty array in case search filter criteria do not match an NF Instance in REGISTERED status). In the latter case, the response may include the noProfileMatchInfo attribute to provide the specific reason for not finding any NF instance that can match the search filter criteria.

2b. On Failure or Redirection:
If the NF Service Consumer is not allowed to discover the NF services for the requested NF type provided in the query parameters, the NRF shall return “403 Forbidden” response.
If the discovery request fails at the NRF due to errors in the input data in the URI query parameters, the NRF shall return “400 Bad Request” status code with the ProblemDetails IE providing details of the error.
If the discovery request fails at the NRF due to NRF internal errors, the NRF shall return “500 Internal Server Error” status code with the ProblemDetails IE providing details of the error.
In the case of redirection, the NRF shall return 3xx status code, which shall contain a Location header with an URI pointing to the endpoint of another NRF service instance.

The NF Profile objects returned in a successful result shall contain generic data of each NF Instance, applicable to any NF type, and it may also contain NF-specific data, for those NF Instances belonging to a specific type (e.g., the attribute “udrInfo” is typically present in the NF Profile when the type of the NF Instance takes the value “UDR”). In addition, the attribute “customInfo”, may be present in the NF Profile for those NF Instances with custom NF types.

For those NF Instances, the “customInfo” attribute shall be returned by NRF, if available, as part of the NF Profiles returned in the discovery response.

The NRF shall also include, in the returned NF Profile objects, the Vendor-Specific attributes (see 3GPP TS 29.500 [4], clause 6.6.3) that may have been provided by the registered NF Instances.

If the response includes a map of NFInstanceInfo objects of NF instances, the NF Service Consumer may retrieve the NF profiles by issuing service discovery requests with the target-nf-instance-id parameter identifying the target NF Instance ID, or with the target-nf-instance-id-list parameter identifying a list of target NF Instance IDs held by the same NRF; the service discovery request shall also include the nrf-disc-uri parameter set to the API URI of the Nnrf_NFDiscovery service of the NRF holding the NF profile(s), if the nrfDiscApiUri attribute was received in the NFInstanceInfo object and if the service discovery request is addressed to a different NRF than the NRF holding the NF profile(s).

FIG. 1e shows a flowchart of service discovery in the different PLMN, which is same as FIG. 5.3.2.2.3-1 of 3GPP 29.510 V18.2.0.

Clause 5.3.2.2.3 of 3GPP 29.510 V18.2.0 describes the steps of FIG. 1e as following.

The service discovery in a different PLMN is done by querying the “nf-instances” resource in the NRF of the Home PLMN.

For that, step 1 in clause 5.3.2.2.2 of 3GPP 29.510 V18.2.0 is executed (send a GET request to the NRF in the Serving PLMN); this request shall include the identity of the PLMN of the home NRF in a query parameter of the URI.

If the NRF in Serving PLMN knows that Oauth2-based authorization is required for accessing the NF Discovery service of the NRF in Home PLMN, e.g. by learning this during an earlier Bootstrapping procedure or local configuration, and if the request received at the NRF in Serving PLMN does not include an access token, the NRF in Serving PLMN may reject the request with a 401 Unauthorized as specified in clause 6.7.3 of 3GPP TS 29.500 [4].

Then, steps 1-2 in FIG. 5.3.2.2.3-1 of 3GPP 29.510 V18.2.0 are executed, between the NRF in the Serving PLMN and the NRF in the Home PLMN. In this step, the presence of the PLMN ID of the Home NRF in the query parameter of the URI is not required. The NRF in the Home PLMN returns a status code with the result of the operation. The NRF in the Serving PLMN shall be configured with:
a telescopic FQDN (see 3GPP TS 23.003 and 3GPP TS 29.500 [4]) of the NRF in the Home PLMN, if TLS protection between the NRF and the SEPP in the serving PLMN relies on using telescopic FQDN; or
NOTE: This is required for the NRF in the serving PLMN to route the NF discovery request to the NRF in the HPLMN through a SEPP in the serving PLMN and the SEPP to terminate the TLS connection with a wildcard certificate.
with the SEPP FQDN (or the FQDN of the SCP if the communication between the NRF and the SEPP goes through an SCP), if TLS protection between the NRF and the SEPP in the serving PLMN relies on using the 3gpp-Sbi-Target-apiRoot header.

See clause 6.1.4.3 of 3GPP TS 29.500 [4].

Finally, step 2 in clause 5.3.2.2.2 of 3GPP 29.510 V18.2.0 is executed; a status code is returned to the NF Service Consumer in Serving PLMN in accordance to the result received from NRF in Home PLMN.

Steps 1 and 2 are similar to steps 1 and 2 in FIG. 5.3.2.2.2-1 of 3GPP 29.510 V18.2.0, where the originator of the service invocation is the NRF in Serving PLMN, and the recipient of the service invocation is the NRF in the Home PLMN.

In practice, the NF consumer may provide certain query parameters that are not supported by the NRF, e.g. the NF consumer has implemented a newer version 3GPP specification than the NRF, or the NRF selectively implemented some query parameters but not all. For latter case, even feature negotiation is not helpful, as specified by 3GPP 29.510 V18.2.0, the feature bit only be set by the NRF when all the query parameters controlled by the feature are supported.

According to 3GPP TS 29.500 V18.1.0, the disclosure of which is incorporated by reference herein in its entirety, in case received unsupported query parameters, there are two options that the NRF may take.

Clause 5.2.9 of 3GPP TS 29.500 V18.1.0 describes handling of unsupported query parameters as following.

Unless specified otherwise for an Application Programming Interface (API), an NF Service Producer that receives an HTTP request with one or more unsupported (i.e. not comprehended) query parameters shall:

a) for Safe HTTP Methods (e.g. HTTP GET Request):
ignore the unsupported query parameters and respond to the request based on the rest of the request (e.g. other supported query parameters); or
reject the HTTP request as specified below for non-safe HTTP methods, e.g. based on other query parameters in the request or based on a response becoming very large;

When the NRF receives an unsupported query parameter, the NRF can select to reject the request or return a search result by ignoring the unsupported query parameter (as specified in 3GPP TS 29.500 V18.1.0), but either way has obvious drawbacks as described above.

There should be a mechanism to help the NRF to understand how to handle the unsupported query parameter(s) and/or help the NF consumer to understand how the discovery result is generated.

To overcome or mitigate at least one of above mentioned problems or other problems, the embodiments of the present disclosure propose an improved solution for NF discovery.

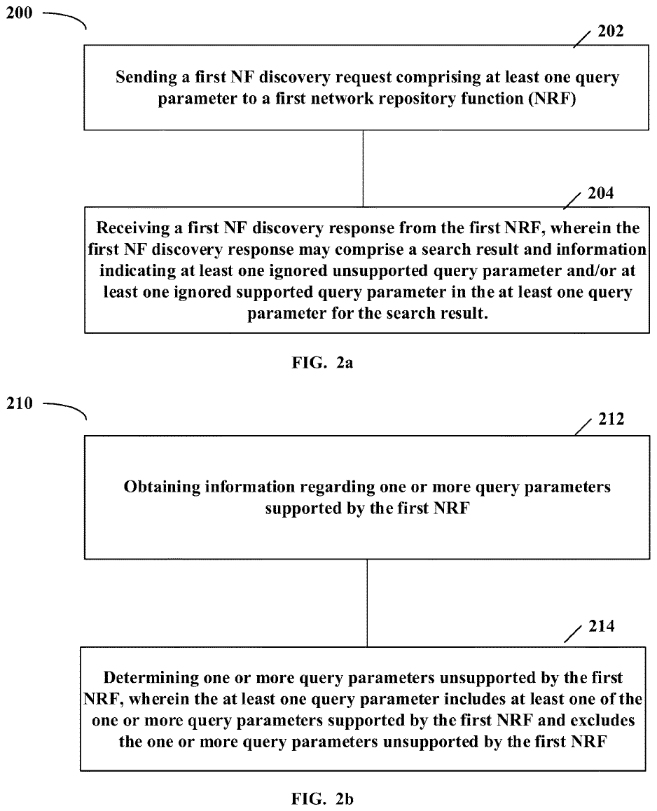

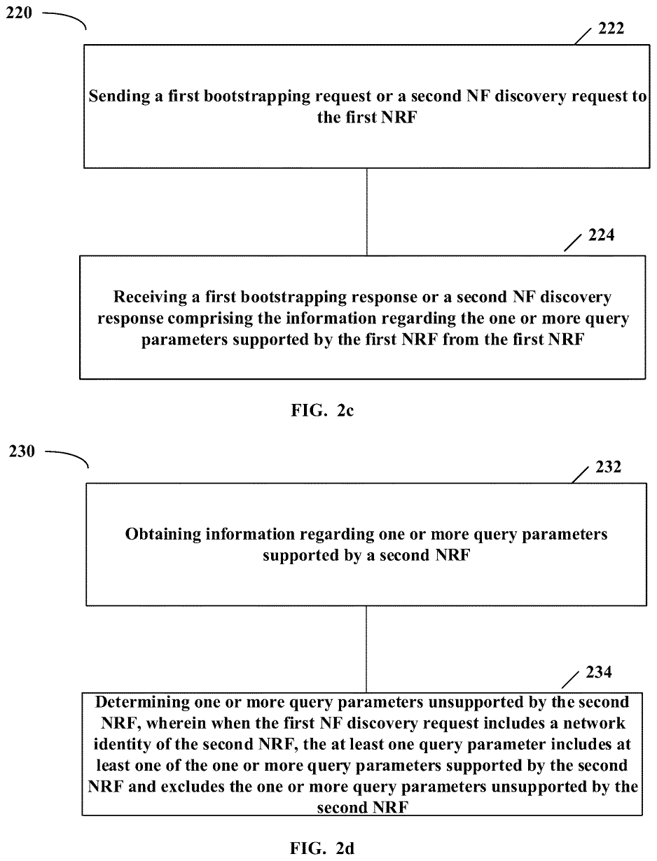

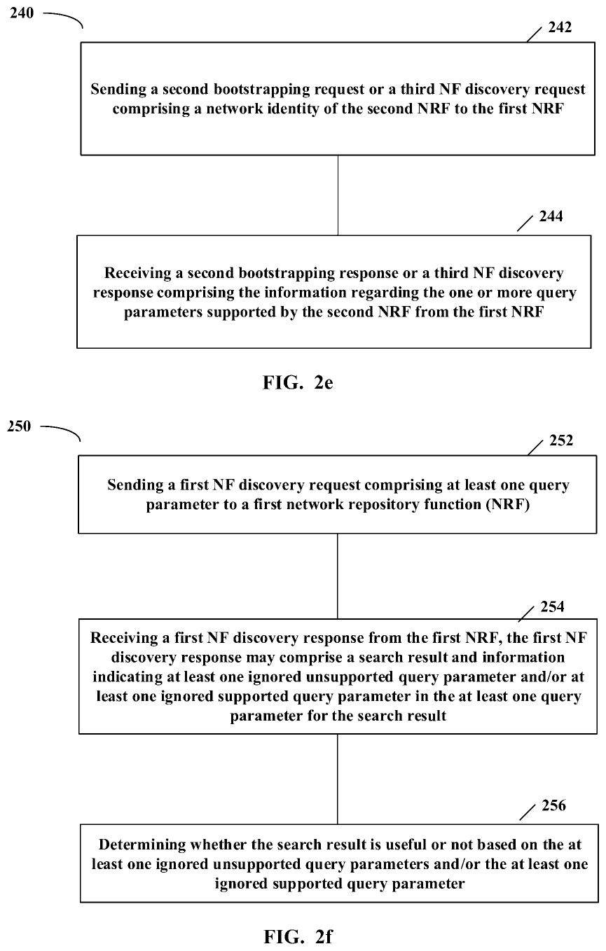

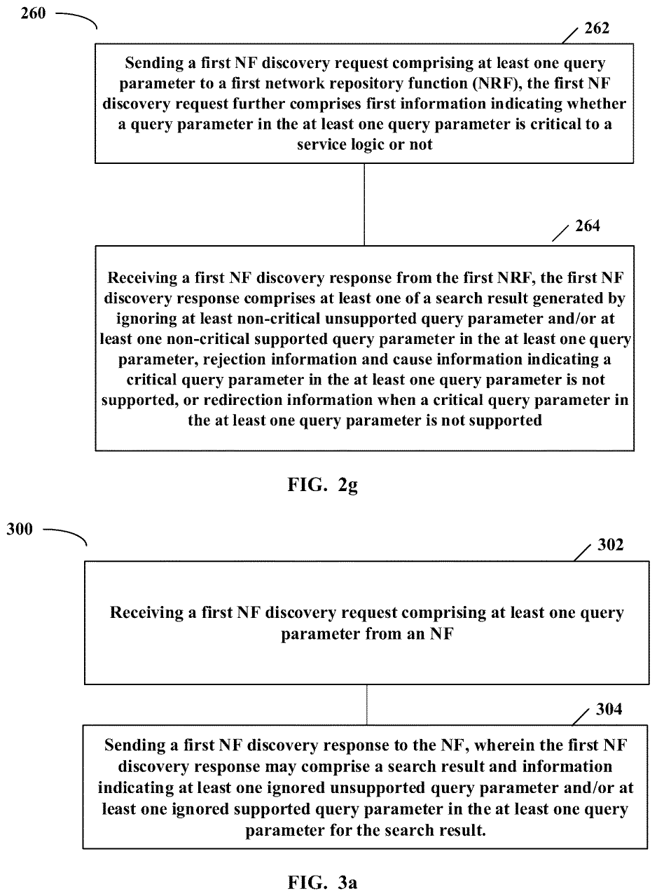

FIG. 2a shows a flowchart of a method according to an embodiment of the present disclosure, which may be performed by an apparatus implemented in/as or communicatively coupled to a network function (NF). As such, the apparatus may provide means for accomplishing various parts of the method 200 as well as means for accomplishing other processes in conjunction with other components.

At block 202, the NF may send a first NF discovery request comprising at least one query parameter to a first network repository function (NRF).

The NF may be any suitable node or entity or function for example as described in various 3GPP specifications such as 3GPP TS 23.501 V18.0.0, 3GPP TS 29.500 V18.1.0, 3GPP 29.510 V18.2.0, 3GPP TS 23.502 V18.0.0, etc.

In an embodiment, the NF may be an NF service consumer or an NF consumer for example as described in various 3GPP specifications such as 3GPP TS 23.501 V18.0.0, 3GPP TS 29.500 V18.1.0, 3GPP 29.510 V18.2.0, 3GPP TS 23.502 V18.0.0, 3GPP TS 23.502 V18.0.0, etc.

The first NRF may be any suitable node or entity or function which can implement network repository function. In an embodiment, the first NRF may be NRF as described in 3GPP TS 23.501 V18.0.0, 3GPP TS 29.500 V18.1.0, 3GPP 29.510 V18.2.0, 3GPP TS 23.502 V18.0.0, etc.

In an embodiment, the NF discovery service may allow an NF or SCP instance to discover other NF instances with the potential services they offer, or to discover SEPP instances in the same PLMN, by querying the local NRF.

In an embodiment, the NF discovery service may allow an SCP to discover other SCP instances.

In an embodiment, the NF discovery service may allow an NF or SCP to discover the list of NRF instances that are part of the NRF set with, for each NRF instance, its NRF instance ID and addressing information, if the NRF is part of an NRF set.

In an embodiment, the NF discovery service may allow an NRF in a PLMN to re-issue a discovery request towards an NRF in another PLMN (e.g., the HPLMN of certain user equipment (UE)).

The first NF discovery request may be an existing message or a new message. In an embodiment, the first NF discovery request may be an Nnrf_NFDiscovery_Request for example as described in 3GPP TS 23.502 V18.0.0 or an HTTP GET request as described in clause 5.3.2.2 of 3GPP 29.510 V18.2.0.

The at least one query parameter may be any suitable query parameter such as existing query parameter or new query parameter. In an embodiment, the at least one query parameter may comprise any query parameter as described in clause 5.2.7.3.2 of 3GPP TS 23.502 V18.0.0 or any query parameter as described in clause 6.2.3.2.3.1 of 3GPP 29.510 V18.2.0.

In an embodiment, the at least one query parameter may include at least one of the one or more query parameters supported by the first NRF and exclude the one or more query parameters unsupported by the first NRF.

In an embodiment, when the first NF discovery request includes a network identity of the second NRF, the at least one query parameter may include at least one of the one or more query parameters supported by the second NRF and exclude the one or more query parameters unsupported by the second NRF.

At block 204, the NF may receive a first NF discovery response from the first NRF.

The first NF discovery response may be an existing message or a new message. In an embodiment, the first NF discovery response may be an Nnrf_NFDiscovery_Request Response for example as described in 3GPP TS 23.502 V18.0.0 or an HTTP GET response as described in clause 5.3.2.2 of 3GPP 29.510 V18.2.0.

In an embodiment, the first NF discovery response may comprise a search result and information indicating at least one ignored unsupported query parameter and/or at least one ignored supported query parameter in the at least one query parameter for the search result.

FIG. 2b shows a flowchart of a method according to another embodiment of the present disclosure, which may be performed by an apparatus implemented in/as or communicatively coupled to an NF. As such, the apparatus may provide means for accomplishing various parts of the method 210 as well as means for accomplishing other processes in conjunction with other components. For some parts which have been described in the above embodiments, the description thereof is omitted here for brevity.

At block 212, the NF may obtain information regarding one or more query parameters supported by the first NRF.

The NF may obtain information regarding one or more query parameters supported by the first NRF in various ways and the present disclosure has no limit on it. For example, the NF may obtain such information from another network device or the first NRF. Such information may be configured in the NF.

For example, when the NF obtains the information regarding one or more query parameters supported by the first NRF from the first NRF, such information may be comprised in any suitable message such as an NF discovery request or an NF discovery response such as a failure NF discovery or a success NF discovery.

At block 214, the NF may determine one or more query parameters unsupported by the first NRF.

The NF may determine one or more query parameters unsupported by the first NRF in various ways and the present disclosure has no limit on it. For example, the NF may obtain such information from another network device or the first NRF. Such information may be configured in the NF.

In an embodiment, the NF may determine one or more query parameters unsupported by the first NRF based on the information regarding one or more query parameters supported by the first NRF.

In an embodiment, the at least one query parameter comprised in the first NF discovery request may include at least one of the one or more query parameters supported by the first NRF and exclude the one or more query parameters unsupported by the first NRF.

FIG. 2c shows a flowchart of a method according to another embodiment of the present disclosure, which may be performed by an apparatus implemented in/as or communicatively coupled to an NF. As such, the apparatus may provide means for accomplishing various parts of the method 220 as well as means for accomplishing other processes in conjunction with other components. For some parts which have been described in the above embodiments, the description thereof is omitted here for brevity.

At block 222, the NF may send a first bootstrapping request or a second NF discovery request to the first NRF.

The second NF discovery request may be an existing message or a new message. In an embodiment, the second NF discovery request may be the Nnrf_NFDiscovery_Request for example as described in 3GPP TS 23.502 V18.0.0 or the HTTP GET request as described in clause 5.3.2.2 of 3GPP 29.510 V18.2.0.

The NRF may offer bootstrapping service to let NF Service Consumers of the NRF know about the services endpoints it supports, the NRF Instance ID (identifier) and NRF Set ID if the NRF is part of an NRF set, by using a version-independent URI (Uniform Resource Identifier) endpoint that does not need to be discovered by using a discovery service.

The bootstrapping service may be used in inter-PLMN scenarios where the NRF in a PLMN-A needs to invoke services from an NRF in PLMN-B, when there is no pre-configured information indicating the version of the services deployed in PLMN-B.

The bootstrapping service may also be used in intra-PLMN scenarios, to avoid configuring statically in the different NFs information about the service versions deployed in the NRF to be used by those NFs.

The first bootstrapping request may be an existing message or a new message. In an embodiment, the first bootstrapping request may be an Nnrf_Bootstrapping_Get request for example as described in 3GPP TS 23.502 V18.0.0 or the HTTP GET request as described in clause 5.5.2.2 of 3GPP 29.510 V18.2.0.

At block 224, the NF may receive a first bootstrapping response or a second NF discovery response comprising the information regarding the one or more query parameters supported by the first NRF from the first NRF.

In an embodiment, the first bootstrapping response or the second NF discovery response may comprise the information regarding the one or more query parameters supported by the first NRF and/or information regarding one or more query parameters unsupported by the first NRF.

The second NF discovery response may be an existing message or a new message. In an embodiment, the second NF discovery response may be an Nnrf_NFDiscovery_Request Response for example as described in 3GPP TS 23.502 V18.0.0 or the HTTP GET response as described in clause 5.3.2.2 of 3GPP 29.510 V18.2.0.

The first bootstrapping response may be an existing message or a new message. In an embodiment, the first bootstrapping response may be an Nnrf_Bootstrapping_Get response for example as described in 3GPP TS 23.502 V18.0.0 or the HTTP GET response as described in clause 5.5.2.2 of 3GPP 29.510 V18.2.0.

FIG. 2d shows a flowchart of a method according to another embodiment of the present disclosure, which may be performed by an apparatus implemented in/as or communicatively coupled to an NF. As such, the apparatus may provide means for accomplishing various parts of the method 230 as well as means for accomplishing other processes in conjunction with other components. For some parts which have been described in the above embodiments, the description thereof is omitted here for brevity.

At block 232, the NF may obtain information regarding one or more query parameters supported by a second NRF.

The NF may obtain information regarding one or more query parameters supported by a second NRF in various ways and the present disclosure has no limit on it. For example, the NF may obtain such information from another network device or the second NRF. Such information may be configured in the NF.

For example, when the NF obtains the information regarding one or more query parameters supported by the second NRF from the second NRF, such information may be comprised in any suitable message such as an NF discovery request or an NF discovery response such as a failure NF discovery or a success NF discovery.

At block 234, the NF may determine one or more query parameters unsupported by the second NRF.

The NF may determine one or more query parameters unsupported by the second NRF in various ways and the present disclosure has no limit on it. For example, the NF may obtain such information from another network device or the second NRF. Such information may be configured in the NF.

In an embodiment, the NF may determine one or more query parameters unsupported by the second NRF based on the information regarding one or more query parameters supported by the second NRF.

In an embodiment, when the first NF discovery request includes a network identity of the second NRF, the at least one query parameter may include at least one of the one or more query parameters supported by the second NRF and exclude the one or more query parameters unsupported by the second NRF.

FIG. 2e shows a flowchart of a method according to another embodiment of the present disclosure, which may be performed by an apparatus implemented in/as or communicatively coupled to an NF. As such, the apparatus may provide means for accomplishing various parts of the method 240 as well as means for accomplishing other processes in conjunction with other components. For some parts which have been described in the above embodiments, the description thereof is omitted here for brevity.

At block 242, the NF may send a second bootstrapping request or a third NF discovery request comprising a network identity of the second NRF to the first NRF.

The network identity of the second NRF may be any identity such as the identity of the PLMN of the second NRF such as home NRF.

The third NF discovery request may be an existing message or a new message. In an embodiment, the third NF discovery request may be an Nnrf_NFDiscovery_Request for example as described in 3GPP TS 23.502 V18.0.0 or the HTTP GET request as described in clause 5.3.2.2 of 3GPP 29.510 V18.2.0.

The second bootstrapping request may be an existing message or a new message. In an embodiment, the second bootstrapping request may be an Nnrf_Bootstrapping_Get request for example as described in 3GPP TS 23.502 V18.0.0 or the HTTP GET request as described in clause 5.5.2.2 of 3GPP 29.510 V18.2.0.

At block 244, the NF may receive a second bootstrapping response or a third NF discovery response comprising the information regarding the one or more query parameters supported by the second NRF from the first NRF.

In an embodiment, the second bootstrapping response or the third NF discovery response may comprise the information regarding the one or more query parameters supported by the second NRF and/or information regarding one or more query parameters unsupported by the second NRF.

The third NF discovery response may be an existing message or a new message. In an embodiment, the third NF discovery response may be an Nnrf_NFDiscovery_Request Response for example as described in 3GPP TS 23.502 V18.0.0 or the HTTP GET response as described in clause 5.3.2.2 of 3GPP 29.510 V18.2.0.

The second bootstrapping response may be an existing message or a new message. In an embodiment, the second bootstrapping response may be an Nnrf_Bootstrapping_Get response for example as described in 3GPP TS 23.502 V18.0.0 or the HTTP GET response as described in clause 5.5.2.2 of 3GPP 29.510 V18.2.0.

In an embodiment, the first NRF may comprise an NRF in a first network or a first service area or a first network slice and the second NRF may comprise an NRF in a second network or a second service area or a second network slice.

In an embodiment, the first NRF may comprise a visited NRF and the second NRF may comprise a home NRF.

In an embodiment, the first NRF may comprise a home NRF and the second NRF may comprise a visited NRF.

FIG. 2f shows a flowchart of a method according to another embodiment of the present disclosure, which may be performed by an apparatus implemented in/as or communicatively coupled to an NF. As such, the apparatus may provide means for accomplishing various parts of the method 250 as well as means for accomplishing other processes in conjunction with other components. For some parts which have been described in the above embodiments, the description thereof is omitted here for brevity.

At block 252, the NF may send a first NF discovery request comprising at least one query parameter to a first NRF.

At block 254, the NF may receive a first NF discovery response from the first NRF.

In an embodiment, the first NF discovery response may comprise a search result and information indicating at least one ignored unsupported query parameter and/or at least one ignored supported query parameter in the at least one query parameter for the search result.

For example, the search result may be generated by ignoring at least one unsupported query parameter and/or at least one supported query parameter in the at least one query parameter.

At block 256, the NF may determine whether the search result is useful or not based on the at least one ignored unsupported query parameters and/or the at least one ignored supported query parameter.

For example, if the at least one ignored unsupported query parameters and/or the at least one ignored supported query parameter is not critical to a service logic, the NF may determine the search result is useful. Otherwise the NF may determine the search result is not useful.

FIG. 2g shows a flowchart of a method according to another embodiment of the present disclosure, which may be performed by an apparatus implemented in/as or communicatively coupled to an NF. As such, the apparatus may provide means for accomplishing various parts of the method 260 as well as means for accomplishing other processes in conjunction with other components. For some parts which have been described in the above embodiments, the description thereof is omitted here for brevity.

At block 262, the NF may send a first NF discovery request comprising at least one query parameter to a first NRF.

In an embodiment, the first NF discovery request may further comprise first information indicating whether a query parameter in the at least one query parameter is critical to a service logic or not.

The first information may be any suitable information and the present disclosure has no limit on it.

In an embodiment, the first information may comprise at least one of a new query parameter including a list of at least one critical query parameter's name, a Hyper Text Transfer Protocol (HTTP) header including a list of at least one critical query parameter's name, or a pattern or extension directly on a query parameter name to indicate a criticality.

At block 264, the NF may receive a first NF discovery response from the first NRF.

In an embodiment, the first NF discovery response may comprise at least one of a search result generated by ignoring at least non-critical unsupported query parameter and/or at least one non-critical supported query parameter in the at least one query parameter, rejection information and cause information indicating a critical query parameter in the at least one query parameter is not supported, or redirection information when a critical query parameter in the at least one query parameter is not supported.

For example, the at least non-critical unsupported query parameter and/or the at least one non-critical supported query parameter in the at least one query parameter may refer to a query parameter which is not essential or critical for the service logic. A critical query parameter in the at least one query parameter may refer to a query parameter which is essential or critical for the service logic.

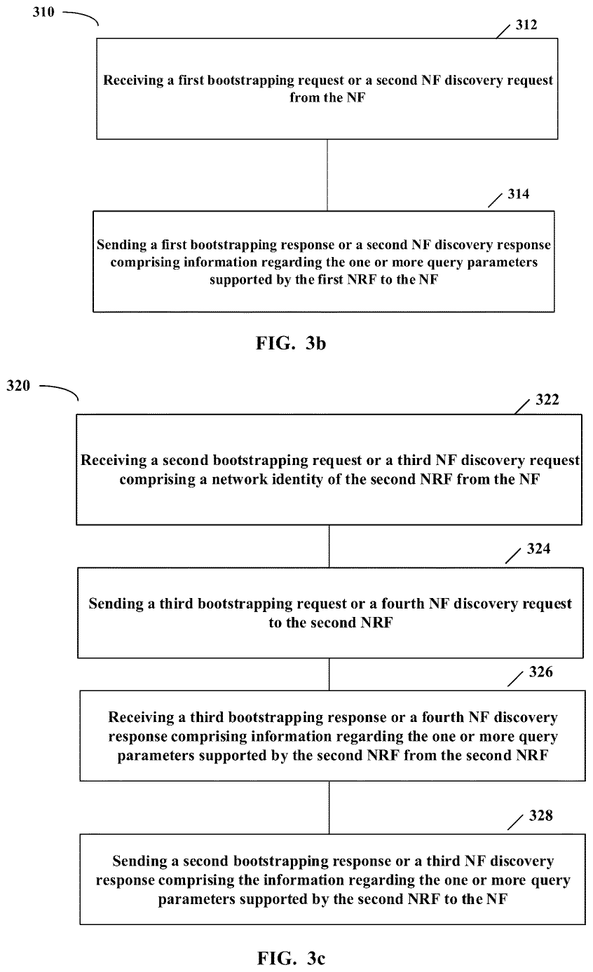

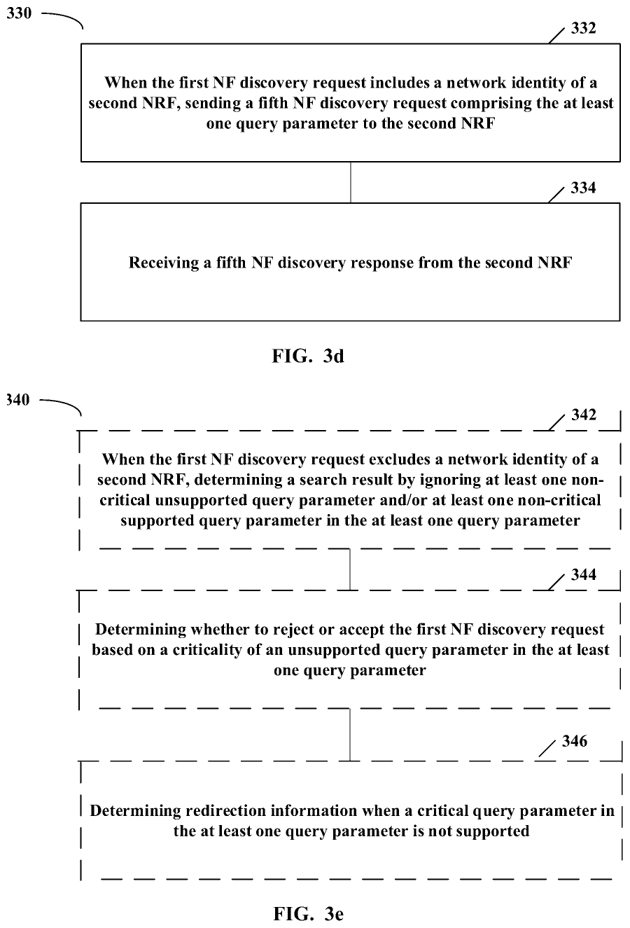

FIG. 3a shows a flowchart of a method according to another embodiment of the present disclosure, which may be performed by an apparatus implemented in/as or communicatively coupled to a first NRF. As such, the apparatus may provide means for accomplishing various parts of the method 300 as well as means for accomplishing other processes in conjunction with other components. For some parts which have been described in the above embodiments, the description thereof is omitted here for brevity.

At block 302, the first NRF may receive a first NF discovery request comprising at least one query parameter from an NF.

At block 304, the first NRF may send a first NF discovery response to the NF.

For example, when the first NRF receives a first NF discovery request comprising at least one query parameter from an NF and the first NF discovery request does not comprise a network identity of a second NRF, the first NRF may process the first NF discovery request. For example, the first NRF may process the first NF discovery request as described in clause 5.3.2.2 of 3GPP 29.510 V18.2.0 or as described in clause 4.17 of 3GPP TS 23.502 V18.0.0. In addition, the first NRF may process the first NF discovery request according the embodiments of the present disclosure.

In an embodiment, the at least one query parameter may include at least one of one or more query parameters supported by the first NRF and exclude one or more query parameters unsupported by the first NRF.

In an embodiment, when the first NF discovery request includes a network identity of a second NRF, the at least one query parameter may include at least one of one or more query parameters supported by a second NRF and exclude one or more query parameters unsupported by the second NRF.

In an embodiment, the first NRF may comprise a visited NRF and the second NRF may comprise a home NRF.

In an embodiment, the first NRF may comprise a home NRF and the second NRF may comprise a visited NRF.

In an embodiment, the first NF discovery response comprises a search result and information indicating at least one ignored unsupported query parameter and/or at least one ignored supported query parameter in the at least one query parameter for the search result.

In an embodiment, the first NF discovery request may further comprise first information indicating whether a query parameter in the at least one query parameter is critical to a service logic or not.

In an embodiment, the first NF discovery response may comprise a search result generated by ignoring at least non-critical unsupported query parameter and/or at least one non-critical supported query parameter in the at least one query parameter, or rejection information and cause information indicating a critical query parameter in the at least one query parameter is not supported, or redirection information when a critical query parameter in the at least one query parameter is not supported.

In an embodiment, the first information may comprise at least one of a new query parameter including a list of at least one critical query parameter's name, an HTTP header including a list of at least one critical query parameter's name, or a pattern or extension directly on a query parameter name to indicate a criticality.

In an embodiment, the search result may be generated by the first NRF or the second NRF.

FIG. 3b shows a flowchart of a method according to another embodiment of the present disclosure, which may be performed by an apparatus implemented in/as or communicatively coupled to a first NRF. As such, the apparatus may provide means for accomplishing various parts of the method 310 as well as means for accomplishing other processes in conjunction with other components. For some parts which have been described in the above embodiments, the description thereof is omitted here for brevity.

At block 312, the first NRF may receive a first bootstrapping request or a second NF discovery request from the NF.

At block 314, the first NRF may send a first bootstrapping response or a second NF discovery response comprising information regarding the one or more query parameters supported by the first NRF to the NF.

FIG. 3c shows a flowchart of a method according to another embodiment of the present disclosure, which may be performed by an apparatus implemented in/as or communicatively coupled to a first NRF. As such, the apparatus may provide means for accomplishing various parts of the method 320 as well as means for accomplishing other processes in conjunction with other components. For some parts which have been described in the above embodiments, the description thereof is omitted here for brevity.

At block 322, the first NRF may receive a second bootstrapping request or a third NF discovery request comprising a network identity of the second NRF from the NF.

At block 324, the first NRF may send a third bootstrapping request or a fourth NF discovery request to the second NRF.

The fourth NF discovery request may be an existing message or a new message. In an embodiment, the fourth NF discovery request may be an Nnrf_NFDiscovery_Request for example as described in 3GPP TS 23.502 V18.0.0 or the HTTP GET request as described in clause 5.3.2.2 of 3GPP 29.510 V18.2.0.

The third bootstrapping request may be an existing message or a new message. In an embodiment, the third bootstrapping request may be an Nnrf_Bootstrapping_Get request for example as described in 3GPP TS 23.502 V18.0.0 or the HTTP GET request as described in clause 5.5.2.2 of 3GPP 29.510 V18.2.0.

At block 326, the first NRF may receive a third bootstrapping response or a fourth NF discovery response comprising information regarding the one or more query parameters supported by the second NRF from the second NRF.

In an embodiment, the third bootstrapping response or the fourth NF discovery response may comprise the information regarding the one or more query parameters supported by the second NRF and/or information regarding one or more query parameters unsupported by the second NRF.

The fourth NF discovery response may be an existing message or a new message. In an embodiment, the fourth NF discovery response may be an Nnrf_NFDiscovery_Request Response for example as described in 3GPP TS 23.502 V18.0.0 or the HTTP GET response as described in clause 5.3.2.2 of 3GPP 29.510 V18.2.0.

The third bootstrapping response may be an existing message or a new message. In an embodiment, the third bootstrapping response may be an Nnrf_Bootstrapping_Get response for example as described in 3GPP TS 23.502 V18.0.0 or the HTTP GET response as described in clause 5.5.2.2 of 3GPP 29.510 V18.2.0.

At block 328, the first NRF may send a second bootstrapping response or a third NF discovery response comprising the information regarding the one or more query parameters supported by the second NRF to the NF.

FIG. 3d shows a flowchart of a method according to another embodiment of the present disclosure, which may be performed by an apparatus implemented in/as or communicatively coupled to a first NRF. As such, the apparatus may provide means for accomplishing various parts of the method 330 as well as means for accomplishing other processes in conjunction with other components. For some parts which have been described in the above embodiments, the description thereof is omitted here for brevity.

At block 332, when the first NF discovery request includes a network identity of a second NRF, the first NRF may send a fifth NF discovery request comprising the at least one query parameter to the second NRF.

For example, after receiving the first NF discovery request including the network identity of a second NRF, the first NRF may send the fifth NF discovery request comprising the at least one query parameter to the second NRF.

The fifth NF discovery request may be an existing message or a new message. In an embodiment, the fifth NF discovery request may be an Nnrf_NFDiscovery_Request for example as described in 3GPP TS 23.502 V18.0.0 or the HTTP GET request as described in clause 5.3.2.2 of 3GPP 29.510 V18.2.0.

At block 334, the first NRF may receive a fifth NF discovery response from the second NRF. Then the first NRF may send the first NF discovery response to the NF.

The fifth NF discovery response may be an existing message or a new message. In an embodiment, the fifth NF discovery response may be an Nnrf_NFDiscovery_Request Response for example as described in 3GPP TS 23.502 V18.0.0 or the HTTP GET response as described in clause 5.3.2.2 of 3GPP 29.510 V18.2.0.

In an embodiment, the fifth NF discovery response may comprise a search result and information indicating at least one ignored unsupported query parameter and/or at least one ignored supported query parameter in the at least one query parameter for the search result.

In an embodiment, the fifth NF discovery request may further comprise first information indicating whether a query parameter in the at least one query parameter is critical to a service logic or not.

In an embodiment, the fifth NF discovery response may comprise at least one of a search result generated by ignoring at least non-critical unsupported query parameter and/or at least one non-critical supported query parameter in the at least one query parameter, rejection information and cause information indicating a critical query parameter in the at least one query parameter is not supported, or redirection information when a critical query parameter in the at least one query parameter is not supported.

FIG. 3e shows a flowchart of a method according to another embodiment of the present disclosure, which may be performed by an apparatus implemented in/as or communicatively coupled to a first NRF. As such, the apparatus may provide means for accomplishing various parts of the method 340 as well as means for accomplishing other processes in conjunction with other components. For some parts which have been described in the above embodiments, the description thereof is omitted here for brevity.

In an embodiment, when the first NF discovery request excludes a network identity of a second NRF (e.g., Service Discovery Request in the same PLMN), at least one of blocks 342, 344, 346 may be performed.

At block 342, optionally, the first NRF may determine a search result by ignoring at least one non-critical unsupported query parameter and/or at least one non-critical supported query parameter in the at least one query parameter.

For example, the first NF discovery request may further comprise first information indicating whether a query parameter in the at least one query parameter is critical to a service logic or not. And then the first NRF may know which query parameter in the at least one query parameter is critical to the service logic. Alternatively, the first NRF may determine which query parameter in the at least one query parameter is critical to the service logic by itself for example based on a pre-configuration or machine learning, etc.

In embodiment, when at least one non-critical query parameter is not unsupported by the first NRF, the first NRF may determine a search result by ignoring at least one non-critical unsupported query parameter.

In embodiment, in case search filter criteria do not match an NF instance, the first NRF may try to ignore at least one non-critical supported query parameter and then determine the search result which may comprise matched NF instance(s).

At block 344, optionally, the first NRF may determine whether to reject or accept the first NF discovery request based on a criticality of an unsupported query parameter in the at least one query parameter. Block 342 may be performed if the first NF discovery request is accepted.

For example, if an unsupported query parameter in the at least one query parameter is critical to the service logic, the first NRF may determine to reject the first NF discovery request. If an unsupported query parameter in the at least one query parameter is not critical to the service logic, the first NRF may determine to accept the first NF discovery request.

At block 346, optionally, the first NRF may determine redirection information when a critical query parameter in the at least one query parameter is not supported.

For example, the redirection information may comprise endpoint information of another NRF which may support at least the critical query parameter(s) in the at least one query parameter. The endpoint information may be any suitable information, such as an URI pointing to the endpoint of another NRF service instance.

For example, in the case of redirection, the first NRF may return 3xx status code, which may contain a location header with an URI pointing to the endpoint of another NRF service instance which may support at least the critical query parameter(s) in the at least one query parameter.

FIG. 4a shows a flowchart of a method according to another embodiment of the present disclosure, which may be performed by an apparatus implemented in/as or communicatively coupled to a second NRF. As such, the apparatus may provide means for accomplishing various parts of the method 400 as well as means for accomplishing other processes in conjunction with other components. For some parts which have been described in the above embodiments, the description thereof is omitted here for brevity.

At block 402, the second NRF may receive a fifth NF discovery request comprising at least one query parameter from a first NRF.

At block 404, the second NRF may send a fifth NF discovery response to the first NRF.

For example, the second NRF may process the fifth NF discovery request as described in clause 5.3.2.2 of 3GPP 29.510 V18.2.0 or as described in clause 4.17 of 3GPP TS 23.502 V18.0.0. In addition, the second NRF may process the fifth NF discovery request according the embodiments of the present disclosure.

In an embodiment, the at least one query parameter may include at least one of one or more query parameters supported by the second NRF and exclude one or more query parameters unsupported by the second NRF.

In an embodiment, the first NRF may comprise a visited NRF and the second NRF may comprise a home NRF.

In an embodiment, the first NRF may comprise a home NRF and the second NRF may comprise a visited NRF.

In an embodiment, the fifth NF discovery response may comprise a search result and information indicating at least one ignored unsupported query parameter and/or at least one ignored supported query parameter in the at least one query parameter for the search result.

In an embodiment, the fifth NF discovery request may further comprise first information indicating whether a query parameter in the at least one query parameter is critical to a service logic or not.

In an embodiment, the fifth NF discovery response may comprise at least one of a search result generated by ignoring at least non-critical unsupported query parameter and/or at least one non-critical supported query parameter in the at least one query parameter, rejection information and cause information indicating a critical query parameter in the at least one query parameter is not supported, or redirection information when a critical query parameter in the at least one query parameter is not supported.

At block 406, the second NRF may determine a search result by ignoring at least one non-critical unsupported query parameter and/or at least one non-critical supported query parameter in the at least one query parameter.

For example, the fifth NF discovery request may further comprise first information indicating whether a query parameter in the at least one query parameter is critical to a service logic or not. And then the second NRF may know which query parameter in the at least one query parameter is critical to the service logic. Alternatively, the second NRF may determine which query parameter in the at least one query parameter is critical to the service logic by itself for example based on a pre-configuration or machine learning, etc.

In embodiment, when at least one non-critical query parameter is not unsupported by the second NRF, the second NRF may determine a search result by ignoring at least one non-critical unsupported query parameter.

In embodiment, in case search filter criteria do not match an NF instance, the second NRF may try to ignore at least one non-critical supported query parameter and then determine the search result which may comprise matched NF instance(s).

FIG. 4b shows a flowchart of a method according to another embodiment of the present disclosure, which may be performed by an apparatus implemented in/as or communicatively coupled to a second NRF. As such, the apparatus may provide means for accomplishing various parts of the method 410 as well as means for accomplishing other processes in conjunction with other components. For some parts which have been described in the above embodiments, the description thereof is omitted here for brevity.

At block 412, the second NRF may receive a third bootstrapping request or a fourth NF discovery request from the first NRF.

At block 414, the second NRF may send a third bootstrapping response or a fourth NF discovery response comprising information regarding the one or more query parameters supported by the second NRF to the first NRF.

FIG. 4c shows a flowchart of a method according to another embodiment of the present disclosure, which may be performed by an apparatus implemented in/as or communicatively coupled to a second NRF. As such, the apparatus may provide means for accomplishing various parts of the method 420 as well as means for accomplishing other processes in conjunction with other components. For some parts which have been described in the above embodiments, the description thereof is omitted here for brevity.

At block 422, optionally, the second NRF may determine whether to reject or accept the fifth NF discovery request based on a criticality of an unsupported query parameter in the at least one query parameter.

For example, if an unsupported query parameter in the at least one query parameter is critical to the service logic, the second NRF may determine to reject the first NF discovery request. If an unsupported query parameter in the at least one query parameter is not critical to the service logic, the second NRF may determine to accept the fifth NF discovery request. Block 422 may be performed if the fifth NF discovery request is accepted.

At block 424, optionally, the second NRF may determine redirection information when a critical query parameter in the at least one query parameter is not supported.

For example, the redirection information may comprise endpoint information of another NRF which may support at least the critical query parameter(s) in the at least one query parameter. The endpoint information may be any suitable information, such as an URI pointing to the endpoint of another NRF service instance.

For example, in the case of redirection, the second NRF may return 3xx status code, which may contain a location header with an URI pointing to the endpoint of another NRF service instance which may support at least the critical query parameter(s) in the at least one query parameter.

In embodiment, a mechanism is proposed to allow the NRF to successfully and efficiently handle the unsupported query parameter(s), either by allowing the NF consumer to know the supported query parameter list to avoid sending unsupported query parameter(s); or to allow the NF consumer to explicitly indicate the criticality of query parameter(s) and the NRF depends on the criticality of the unsupported query parameter(s) and/or the criticality of the supported query parameter(s) and decide to reject or accept the NF discovery request.

In embodiment, there may be different possible solutions to resolve at least one of the above mentioned problems.

In an embodiment, it is provided a solution-1: the NRF may tell the NF consumer which query parameters set (or query parameter(s)) is supported.

In an embodiment, a mechanism may be introduced to allow the NRF to tell the NF consumer about supported query parameters set (or supported query parameter(s)) to avoid the NF consumer providing unsupported query parameter(s) and the NRF receiving the unsupported query parameter(s).

In an embodiment, it is provided a solution-1.1: the supported query parameters set (or query parameter(s)) can be provided via NRF bootstrap service. In an embodiment, a NRF such as vNRF may relay bootstrap service message to another NRF such as hNRF.

In an embodiment, it is provided a solution-1.2: the supported query parameters set (or query parameter(s)) can be provided in a response of a discovery request, e.g., a failure response of a discovery request due to unsupported query parameter(s) or a success response of a discovery request.

In an embodiment, the supported query parameters set (or query parameter(s)) may be returned in other response (or message) to proactively avoid using unsupported query parameter(s).

FIG. 5a shows a flowchart of solution-1.1 according to an embodiment of the present disclosure.

At step 501. The NF consumer may send a GET/bootstrapping request as described in clause 5.5.2.2.1 of 3GPP 29.510 V18.2.0 to vNRF.

At step 502. The NF consumer may receive a GET/bootstrapping response as described in clause 5.5.2.2.1 of 3GPP 29.510 V18.2.0 from the vNRF. The GET/bootstrapping response may comprise a body: BootStrapingInfo (supported Query Parameters Set).

At step 503. The NF consumer may determine the unsupported query parameter(s) of vNRF.

At step 504. The NF consumer may send an Nnrf_NFDiscovery_Request as described in 3GPP 23.502 V18.0.0 to the vNRF and avoid comprising unsupported query parameter(s) in Nnrf_NFDiscovery_Request.

The following steps are used in NF/NF service discovery across PLMNs.

At step 505. The NF consumer may send a GET/bootstrapping request comprising plmn={HPLMN ID} to vNRF.

At step 506. The vNRF may send a GET/bootstrapping request to hNRF.

At step 507. The vNRF may receive a GET/bootstrapping response comprising a body: BootStrapingInfo (supported Query Parameters Set) from hNRF and send the response to the NF consumer.

At step 508. The NF consumer may determine the unsupported query parameter(s) of hNRF

At step 509. The NF consumer may send an Nnrf_NFDiscovery_Request to hNRF via vNRF and avoid comprising unsupported query parameter(s) in Nnrf_NFDiscovery_Request.

FIG. 5b shows a flowchart of solution-1.2 according to an embodiment of the present disclosure.

At step 511. The NF consumer may send an Nnrf_NFDiscovery_Request (with unsupported query parameter) as described in 3GPP 23.502 V18.0.0 to vNRF.

At step 512. The NF consumer may receive an Nnrf_NFDiscovery_Request Response as described in 3GPP 23.502 V18.0.0 from the vNRF. The Nnrf_NFDiscovery_Request Response may comprise a body: ProblemDetails (supported Query Parameters Set).

At step 513. The NF consumer may determine the unsupported query parameter(s) of vNRF.

At step 514. The NF consumer may send an Nnrf_NFDiscovery request to the vNRF and avoid comprising unsupported query parameter(s) in Nnrf_NFDiscovery request.

The following steps are used in NF/NF service discovery across PLMNs.

At step 515. The NF consumer may send an Nnrf_NFDiscovery_Request (with unsupported query parameter) to vNRF and vNRF may send the Nnrf_NFDiscovery_Request (with unsupported query parameter) to hNRF.

At step 516. The vNRF may receive an Nnrf_NFDiscovery_Request Response comprising a body: ProblemDetails (supported Query Parameters Set) from hNRF and send the Response to the NF consumer.

At step 517. The NF consumer may determine the unsupported query parameter(s) of hNRF

At step 518. The NF consumer may send an Nnrf_NFDiscovery request to hNRF via vNRF and avoid comprising unsupported query parameter(s) in Nnrf_NFDiscovery request.

In an embodiment, it is provided a solution 2: the NRF may indicate the ignored query parameter(s) (if any) in the discovery/search result.

In an embodiment, if the NRF chooses to proceed the discovery request by ignoring unsupported query parameter(s) and/or supported query parameter(s), the NRF may include an information element (IE) indicating the ignored unsupported query parameter(s) and/or supported query parameter(s) for this search result. Then the NF consumer can, based on the ignored unsupported query parameter(s) and/or supported query parameter(s), identify whether the search result is usable or not, e.g. the search result is not usable if a certain ignored query parameter is critical to the service logic.

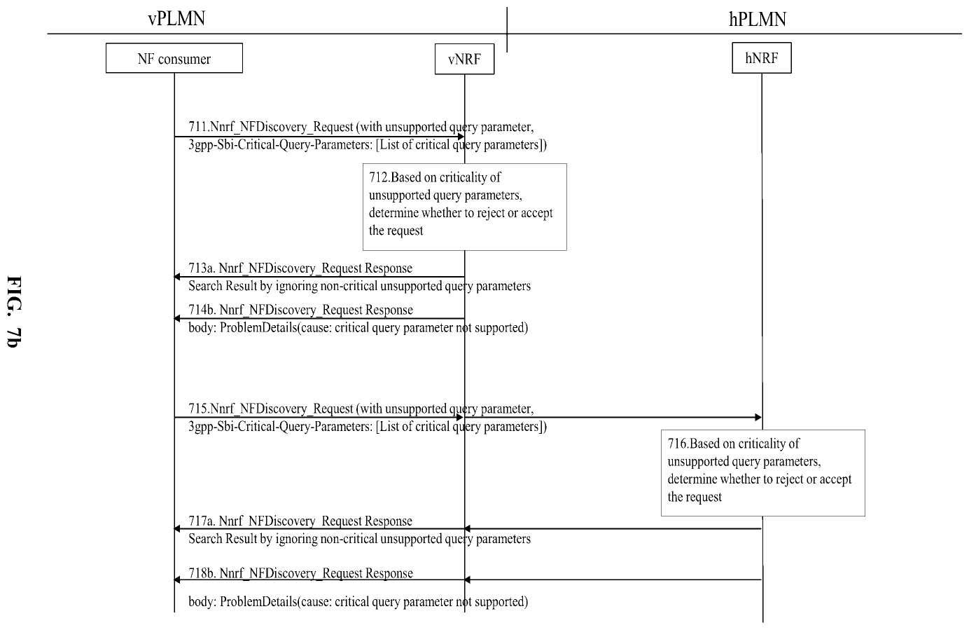

FIG. 6 shows a flowchart of solution 2 according to an embodiment of the present disclosure.

At step 601. The NF consumer may send an Nnrf_NFDiscovery_Request (with unsupported query parameter) as described in 3GPP 23.502 V18.0.0 to vNRF.

At step 602. The NF consumer may receive an Nnrf_NFDiscovery_Request Response as described in 3GPP 23.502 V18.0.0 from the vNRF. The Nnrf_NFDiscovery_Request Response may comprise a body: Search Result by ignoring unsupported query parameter(s) (Ignored Query Parameter(s)).

At step 603. Based on ignored query parameter(s), the NF consumer may determine whether the search result is useful or not.

The following steps are used in NF/NF service discovery across PLMNs.

At step 604. The NF consumer may send an Nnrf_NFDiscovery_Request (with unsupported query parameter) as described in 3GPP 23.502 V18.0.0 to hNRF via vNRF.

At step 605. The NF consumer may receive an Nnrf_NFDiscovery_Request Response as described in 3GPP 23.502 V18.0.0 from hNRF via the vNRF. The Nnrf_NFDiscovery_Request Response may comprise a body: Search Result by ignoring unsupported query parameter(s) (Ignored Query Parameters).

At step 606. Based on ignored query parameter(s), the NF consumer may determine whether the search result is useful or not.

In an embodiment, it is provided a solution-3: the NF consumer may indicate the criticality of query parameter(s) in the discovery request.

In an embodiment, a mechanism may be introduced to allow the NF consumer to explicitly indicate the criticality of the query parameter(s) in the discovery request. As the NF consumer may know the usage of a (or each) query parameter in the discovery request, it can make whether a certain query parameter is critical to service logic or not. The NRF may, based on the criticality of the unsupported query parameter(s), identify whether to continue to process (e.g., if the unsupported query parameter(s) is non-critical) the discovery request or reject the discovery request (if the unsupported query parameter(s) is critical).

In an embodiment, indication of criticality may be provided in different ways. For example, it may use a new query parameter including the list of critical query parameters' names. Tt may use a new (3GPP custom) HTTP header including the list of critical query parameters' names. A pattern/extension directly on the query parameter name may be used to indicate the criticality, e.g. add an extension “:m”/“:o” at the end of query parameter to indicate the criticality.

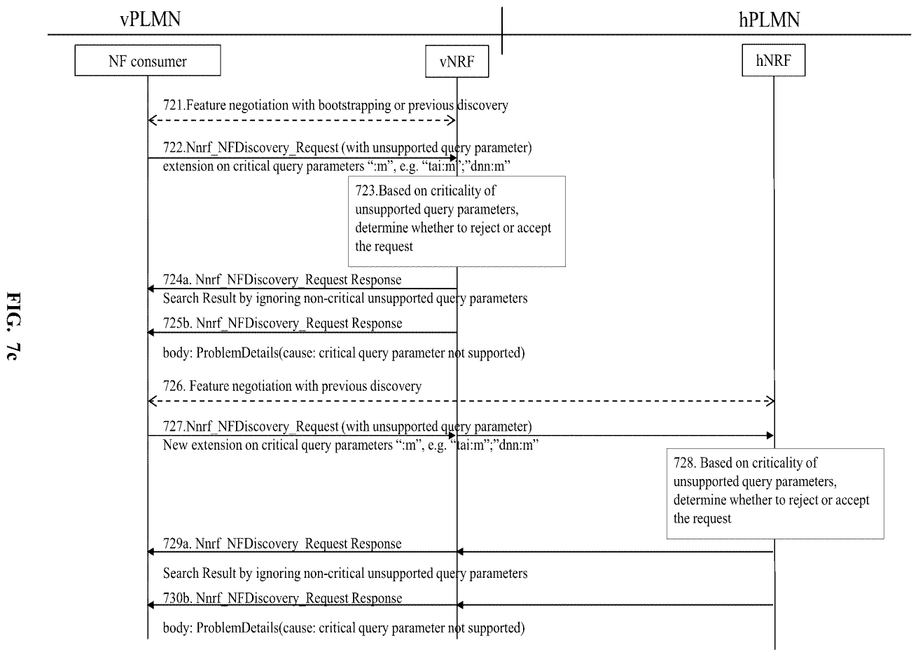

FIG. 7a shows a flowchart of solution 3 according to another embodiment of the present disclosure.

At step 701. Feature negotiation with bootstrapping or previous discovery between the NF consumer and the vNRF is performed.

At step 702. The NF consumer may send an Nnrf_NFDiscovery_Request (with unsupported query parameter, critical-query-parameter-list: [List of critical query parameters]) to vNRF.

At step 703. Based on the criticality of unsupported query parameter(s), vNRF may determine whether to reject or accept the request.

One of steps 704a and 705b may be performed.

At step 704a. vNRF may send an Nnrf_NFDiscovery_Request Response comprising a search result by ignoring non-critical unsupported query parameter(s) to the NF consumer.

At step 705b. vNRF may send an Nnrf_NFDiscovery_Request Response comprising a body: ProblemDetails (cause: critical query parameter not supported) to the NF consumer.

The following steps are used in NF/NF service discovery across PLMNs.

At step 706. Feature negotiation with previous discovery between the NF consumer and the hNRF may be performed.

At step 707. The NF consumer may send an Nnrf_NFDiscovery_Request (with unsupported query parameter, critical-query-parameter-list: [List of critical query parameters]) to hNRF via vNRF.

At step 708. Based on criticality of unsupported query parameters, the hNRF may determine whether to reject or accept the request.

One of steps 709a and 710b may be performed.

At step 709a. hNRF may send an Nnrf_NFDiscovery_Request Response comprising a search result by ignoring non-critical unsupported query parameter(s) to the NF consumer via vNRF.

At step 710b. hNRF may send an Nnrf_NFDiscovery_Request Response comprising a body: ProblemDetails (cause: critical query parameter not supported) to the NF consumer via vNRF.

FIG. 7b shows a flowchart of solution 3 according to another embodiment of the present disclosure.

At step 711. The NF consumer may send an Nnrf_NFDiscovery_Request (with unsupported query parameter, 3gpp-Sbi-Critical-Query-Parameters: [List of critical query parameters]) to vNRF.

At step 712. Based on criticality of unsupported query parameters, vNRF may determine whether to reject or accept the request.

One of steps 713a and 714b may be performed.

At step 713a. vNRF may send an Nnrf_NFDiscovery_Request Response comprising a search result by ignoring non-critical unsupported query parameter(s) to the NF consumer.

At step 714b. vNRF may send an Nnrf_NFDiscovery_Request Response comprising a body: ProblemDetails (cause: critical query parameter not supported) to the NF consumer. The following steps are used in NF/NF service discovery across PLMNs.

At step 715. The NF consumer may send an Nnrf_NFDiscovery_Request (with unsupported query parameter, 3gpp-Sbi-Critical-Query-Parameters: [List of critical query parameters]) to hNRF via vNRF.

At step 716. Based on criticality of unsupported query parameters, the hNRF may determine whether to reject or accept the request.

One of steps 717a and 718b may be performed.

At step 717a. hNRF may send an Nnrf_NFDiscovery_Request Response comprising a search result by ignoring non-critical unsupported query parameter(s) to the NF consumer via vNRF.

At step 718b. hNRF may send an Nnrf_NFDiscovery_Request Response comprising a body: ProblemDetails (cause: critical query parameter not supported) to the NF consumer via vNRF.

FIG. 7c shows a flowchart of solution 3 according to another embodiment of the present disclosure.

At step 721. Feature negotiation with bootstrapping or previous discovery between the NF consumer and the vNRF is performed.

At step 722. The NF consumer may send an Nnrf_NFDiscovery_Request (with unsupported query parameter) to vNRF. There may be an extension on critical query parameters “:m”, e.g. “tai:m”; “dnn:m”.

At step 723. Based on criticality of unsupported query parameters, vNRF may determine whether to reject or accept the request.

One of steps 724a and 725b may be performed.

At step 724a. vNRF may send an Nnrf_NFDiscovery_Request Response comprising a search result by ignoring non-critical unsupported query parameter(s) to the NF consumer.

At step 725b. vNRF may send an Nnrf_NFDiscovery_Request Response comprising a body: ProblemDetails (cause: critical query parameter not supported) to the NF consumer.

The following steps are used in NF/NF service discovery across PLMNs.

At step 726. Feature negotiation with previous discovery between the NF consumer and the hNRF may be performed.

At step 727. The NF consumer may send an Nnrf_NFDiscovery_Request (with unsupported query parameter) to hNRF via vNRF. There is an extension on critical query parameters “:m”, e.g. “tai:m”; “dnn:m”.

At step 728. Based on criticality of unsupported query parameters, the hNRF may determine whether to reject or accept the request.

One of steps 729a and 730b may be performed.

At step 729a. hNRF may send an Nnrf_NFDiscovery_Request Response comprising a search result by ignoring non-critical unsupported query parameter(s) to the NF consumer via vNRF.

At step 720b. hNRF may send an Nnrf_NFDiscovery_Request Response comprising a body: ProblemDetails (cause: critical query parameter not supported) to the NF consumer via vNRF.

Some messages of FIGS. 5A, 5B, 6, 7A, 7B and 7C may be same as the corresponding messages as described in 3GPP TS 23.502 V18.0.0 or 3GPP 29.510 V18.2.0. Some messages of FIGS. 5A, 5B, 6, 7A, 7B and 7C are amended according to some embodiments of the present disclosure.

The following Table 1 lists the evaluation of different solutions and consideration factors:

TABLE 1

| | | | Solution-2 the NRF | | | |
|---|---|---|---|---|---|---|
| | Solution-1 the NRF tell the NF consumer | | indicate the ignored | Sloution-3 the NF consumer may indicate the | | |
| | which query parameters set are supported | | query parameter | criticality of query parameters in discovery request | | |
| | 1.1 via Nnrf | 1.2 in Failure | (if any) in the | 3.1 new Query | 3.2 new HTTP | 3.3 query parameter |
| | Bootstrap service | Response | discovery result | parameter | header | extension |
| Backward | No impact on | No impact on | No impact on | New IE is another | No impact on | Extended query |
| compatibility | legacy NF | legacy NF | legacy NF | unsupported | legacy NF | parameters will |
| | consumer/NRF | consumer/NRF | consumer/NRF | query parameter | consumer/NRF | not supported |
| | | | | for legacy NRF | | by legacy NRF |
| | | | | (feature bit needed) | | (feature bit needed) |
| Support to | Bootstrap | Same NRF to be | Support to all | Feature negotiation | Support to all | Feature negotiation |
| different | required before | used for subsequent | scenarios | required before | scenarios | required before |
| discovery | discovery. | discovery requests. | | discovery. | | discovery. |
| scenarios | Support for | Support for | | Support for | | Support for |
| | Communication | Communication | | Communication | | Communication |
| | Model B & C. | Model B & C. | | Model B & C. | | Model B & C. |
| | Poorly support | Poorly support | | Poorly support | | Poorly support |
| | Communication | Communication | | Communication | | Communication |
| | Model D and | Model D and | | Model D and | | Model D and |
| | inter-PLMN | inter-PLMN | | inter-PLMN | | inter-PLMN |
| | discovery | discovery. | | discovery | | discovery |
| Negative KPI | No NRF rejection | NRF rejection | No NRF rejection | NRF rejection | NRF rejection | NRF rejection |
| (NRF | | occurs when any | | occurs when | occurs when | occurs when |
| rejection) | | unsupported | | critical query | critical query | critical query |
| | | query parameter | | parameter not | parameter not | parameter not |
| | | received. | | supported | supported | supported |
| Traffic | No traffic waste | No traffic waste | Search result with | No traffic waste | No traffic waste | No traffic waste |
| Efficiency | | | big data may not | | | |
| | | | usable for NF | | | |
| | | | consumer, waste | | | |
| | | | of network loads | | | |

Communication Models B, C and D are described in Annex E of 3GPP TS 23.501 V18.0.0 as following.

Model B—Direct communication with NRF interaction: Consumers do discovery by querying the NRF. Based on the discovery result, the consumer does the selection. The consumer sends the request to the selected producer.

Model C—Indirect communication without delegated discovery: Consumers do discovery by querying the NRF. Based on discovery result, the consumer does the selection of an NF Set or a specific NF instance of NF set. The consumer sends the request to the SCP containing the address of the selected service producer pointing to a NF service instance or a set of NF service instances. In the latter case, the SCP selects an NF Service instance. If possible, the SCP interacts with NRF to get selection parameters such as location, capacity, etc. The SCP routes the request to the selected NF service producer instance.

Model D—Indirect communication with delegated discovery: Consumers do not do any discovery or selection. The consumer adds any necessary discovery and selection parameters required to find a suitable producer to the service request. The SCP uses the request address and the discovery and selection parameters in the request message to route the request to a suitable producer instance. The SCP can perform discovery with an NRF and obtain a discovery result.

Solution-1.1 and Solution-3.1&3.3 require the NF consumer before discovery needs to detect the NRF supported feature or invocation the bootstrap service on the NRF to identify which query parameter(s) can be included in discovery request (or whether the extension is allowed). This requirement makes the solutions not very compatible with Communication Model D and inter-PLMN discovery where the NF consumer doesn't really know which NRF will eventually handle the discovery request.

Solution-1.2 requires the same NRF, which provided the supported query parameters set in the first rejection, to be used for subsequent discovery request, although it may not be an issue considering the possibly homogenous deployments of NRF within one PLMN in practice. Another drawback is that rejection will happen when any unsupported query parameter received which brings negative Key Performance Indicator (KPI) impacts.

Soluion-2 fulfils all communication scenarios. This solution also avoids NRF rejection as negative KPI with the cost that the search result (usually quite big) may not be usable by the NF consumer.

Solution-3.2 fulfils all scenarios and avoids unnecessary search result to be returned. The rejections (due to critical query parameter not supported) may be considered acceptable or even expected.

It is recommended to go for Solution-3.2, introduction new HTTP custom header to indicate the criticality of query parameters, which may be the way forward.

Solution-2 may also be helpful for NF consumer to know which query parameters are ignored for search result, which can be work together with Solution-3.2.

Many advantages may be achieved by applying the proposed solution according to embodiments of the present disclosure. In some embodiments herein, it can provide a coordinated way for NRF and NF consumer to perform NF discovery. In some embodiments herein, it can remove ambiguity on the behavior of NRF handling the request and NF consumer handling the search result when query parameters provided by NF consumer may not be supported by NRF. In some embodiments herein, it can avoid network traffic waste and avoid negative KPI due to rejection on service requests. The embodiments herein are not limited to the features and advantages mentioned above. A person skilled in the art will recognize additional features and advantages upon reading the following detailed description.

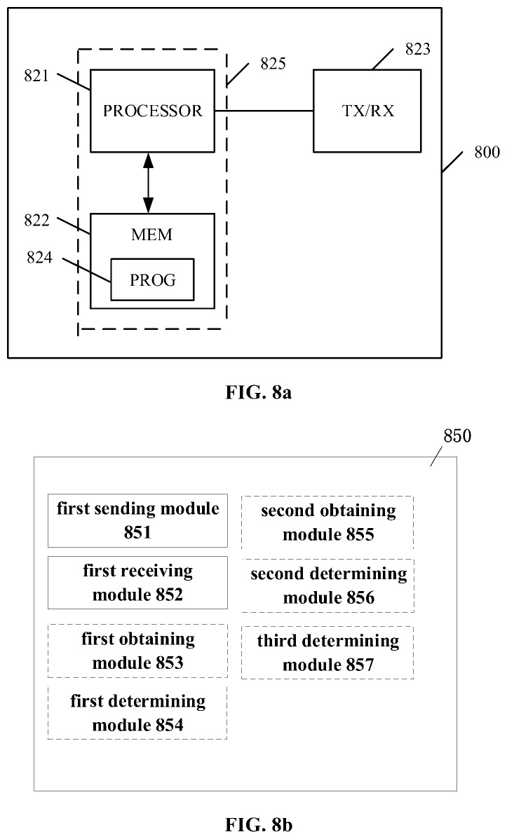

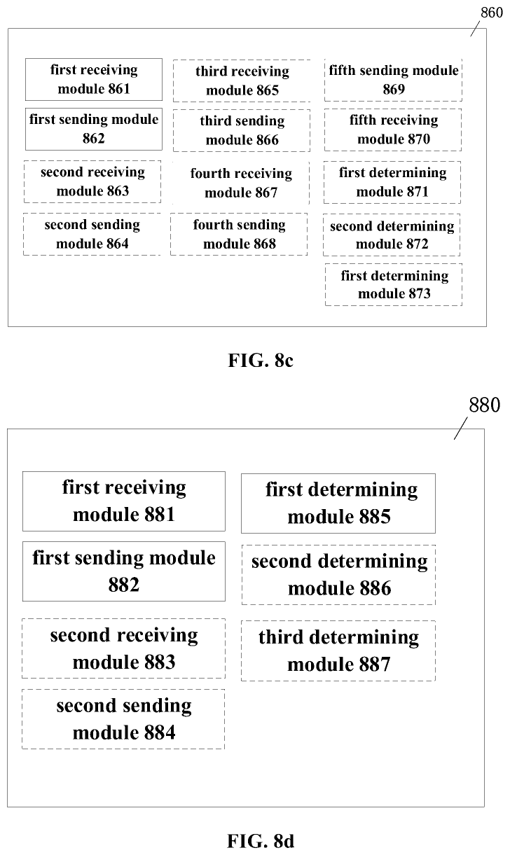

FIG. 8a is a block diagram showing an apparatus suitable for practicing some embodiments of the disclosure. For example, the NF, the first NRF or the second NRF described above may be implemented as or through the apparatus 800.

The apparatus 800 may comprise at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the NF, the memory 822 contains instructions executable by the processor 821, whereby the NF operates according to any of the methods performed by the NF as described above.

In an embodiment where the apparatus is implemented as or at the first NRF, the memory 822 contains instructions executable by the processor 821, whereby the first NRF operates according to any of the methods performed by the first NRF as described above.

In an embodiment where the apparatus is implemented as or at the second NRF, the memory 822 contains instructions executable by the processor 821, whereby the second NRF operates according to any of the methods performed by the second NRF as described above.

FIG. 8b is a block diagram showing an NF according to an embodiment of the disclosure. As shown, the NF 850 may comprise a first sending module 851 configured to send a first NF discovery request comprising at least one query parameter to a first network repository function (NRF). The NF 850 may comprise a first receiving module 852 configured to receive a first NF discovery response from the first NRF. The first NF discovery response may comprise a search result and information indicating at least one ignored unsupported query parameter and/or at least one ignored supported query parameter in the at least one query parameter for the search result.

In an embodiment, the NF 850 may further comprise a first obtaining module 853 configured to obtain information regarding one or more query parameters supported by the first NRF.

In an embodiment, the NF 850 may further comprise a first determining module 854 configured to determine one or more query parameters unsupported by the first NRF. The at least one query parameter may include at least one of the one or more query parameters supported by the first NRF and exclude the one or more query parameters unsupported by the first NRF.

In an embodiment, the NF 850 may further comprise a second obtaining module 855 configured to obtain information regarding one or more query parameters supported by a second NRF.

In an embodiment, the NF 850 may further comprise a second determining module 856 configured to determine one or more query parameters unsupported by the second NRF. When the first NF discovery request includes a network identity of the second NRF, the at least one query parameter may include at least one of the one or more query parameters supported by the second NRF and excludes the one or more query parameters unsupported by the second NRF.

In an embodiment, the NF 850 may further comprise a third determining module 857 configured to determine whether the search result is useful or not based on the at least one ignored unsupported query parameters and/or the at least one ignored supported query parameter.

FIG. 8c is a block diagram showing a first NRF according to an embodiment of the disclosure. As shown, the first NRF 860 may comprise a first receiving module 861 configured to receive a first NF discovery request comprising at least one query parameter from an NF. The first NRF 860 may further comprise a first sending module 862 configured to send a first NF discovery response to the NF. The first NF discovery response may comprise a search result and information indicating at least one ignored unsupported query parameter and/or at least one ignored supported query parameter in the at least one query parameter for the search result.

In an embodiment, the first NRF 860 may comprise a second receiving module 863 configured to receive a first bootstrapping request or a second NF discovery request from the NF.

In an embodiment, the first NRF 860 may further comprise a second sending module 864 configured to send a first bootstrapping response or a second NF discovery response comprising information regarding the one or more query parameters supported by the first NRF to the NF.

In an embodiment, the first NRF 860 may further comprise a third receiving module 865 configured to receive a second bootstrapping request or a third NF discovery request comprising a network identity of the second NRF from the NF.

In an embodiment, the first NRF 860 may further comprise a third sending module 866 configured to send a third bootstrapping request or a fourth NF discovery request to the second NRF.

In an embodiment, the first NRF 860 may further comprise a fourth receiving module 867 configured to receive a third bootstrapping response or a fourth NF discovery response comprising information regarding the one or more query parameters supported by the second NRF from the second NRF.

In an embodiment, the first NRF 860 may further comprise a fourth sending module 868 configured to send a second bootstrapping response or a third NF discovery response comprising the information regarding the one or more query parameters supported by the second NRF to the NF.

In an embodiment, when the first NF discovery request includes a network identity of a second NRF, the first NRF 860 may further comprise a fifth sending module 869 configured to send a fifth NF discovery request comprising the at least one query parameter to the second NRF. The first NRF 860 may further comprise a fifth receiving module 870 configured to receive a fifth NF discovery response from the second NRF.

In an embodiment, when the first NF discovery request excludes a network identity of a second NRF, the first NRF 860 may further comprise a first determining module 871 configured to determine a search result by ignoring at least one non-critical unsupported query parameter and/or at least one non-critical supported query parameter in the at least one query parameter. The first NRF 860 may further comprise a second determining module 872 configured to determine whether to reject or accept the first NF discovery request based on a criticality of an unsupported query parameter in the at least one query parameter. The first NRF 860 may further comprise a first determining module 873 configured to determine redirection information when a critical query parameter in the at least one query parameter is not supported.

FIG. 8d is a block diagram showing a second NRF according to an embodiment of the disclosure. As shown, the second NRF 880 may comprise a first receiving module 881 configured to receive a fifth NF discovery request comprising at least one query parameter from a first NRF. The second NRF 880 may further comprise a first sending module 882 configured to send a fifth NF discovery response to the first NRF.

In an embodiment, the second NRF 880 may further comprise a second receiving module 883 configured to receive a third bootstrapping request or a fourth NF discovery request from the first NRF. The second NRF 880 may further comprise a second sending module 884 configured to send a third bootstrapping response or a fourth NF discovery response comprising information regarding the one or more query parameters supported by the second NRF to the first NRF.

In an embodiment, the second NRF 880 may further comprise a first determining module 885 configured to determine a search result by ignoring at least one non-critical unsupported query parameter and/or at least one non-critical supported query parameter in the at least one query parameter.

In an embodiment, the second NRF 880 may further comprise a second determining module 886 configured to determine whether to reject or accept the fifth NF discovery request based on a criticality of an unsupported query parameter in the at least one query parameter.

In an embodiment, the second NRF 880 may further comprise a third determining module 887 configured to determine redirection information when a critical query parameter in the at least one query parameter is not supported.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the NF, the first NRF or the second NRF may not need a fixed processor or memory, any computing resource and storage resource may be arranged from the NF, the first NRF or the second NRF in the communication system. The introduction of virtualization technology and network computing technology may improve the usage efficiency of the network resources and the flexibility of the network.

Further, the exemplary overall commutation system including the terminal device (such as UE) and the network node (such as the NF, the first NRF or the second NRF) will be introduced as below.

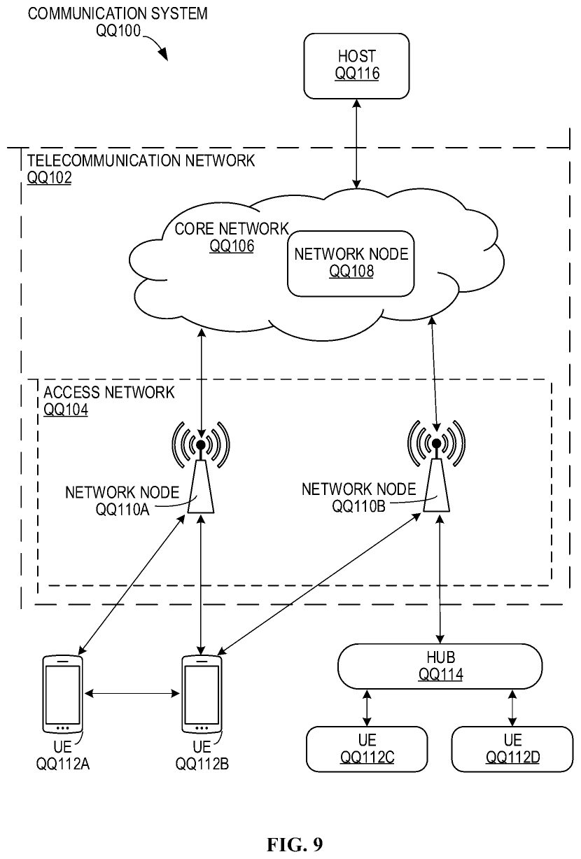

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

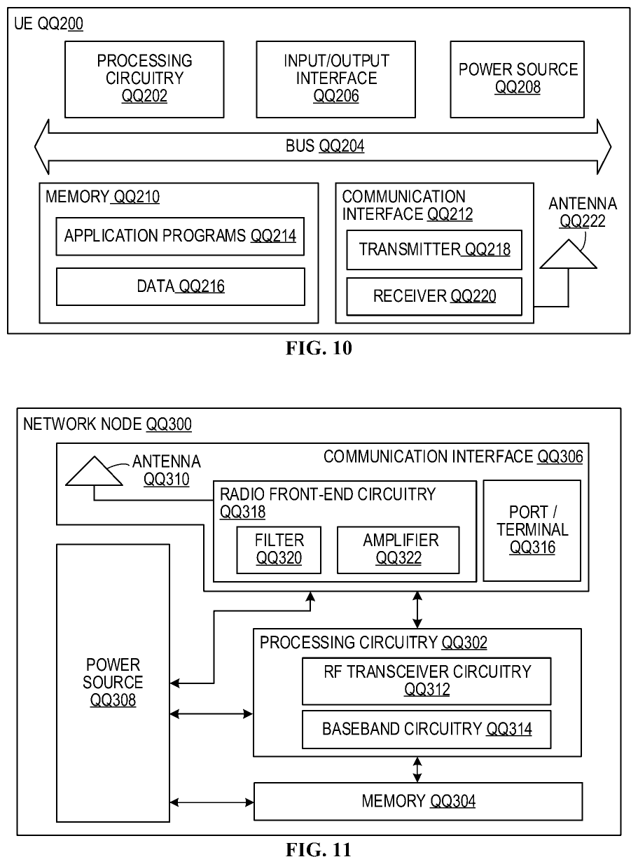

FIG. 10 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 11 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

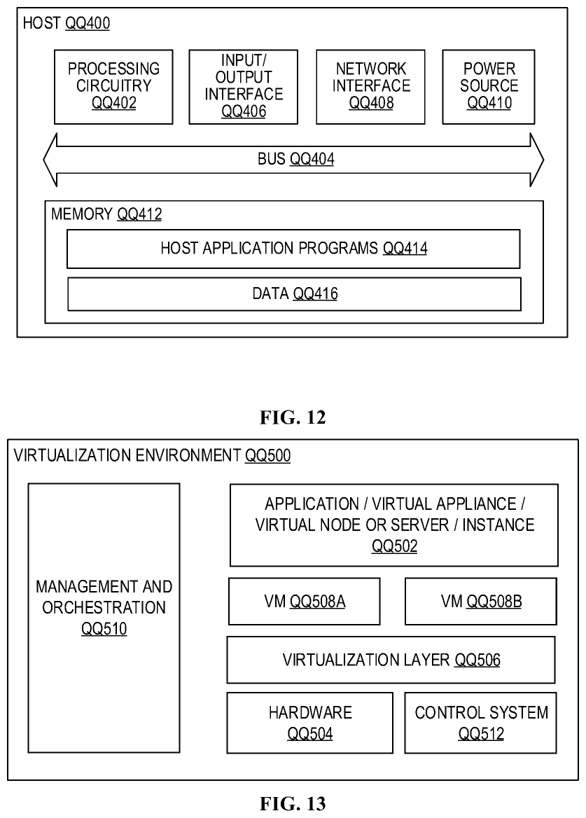

FIG. 12 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508A and QQ508B (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

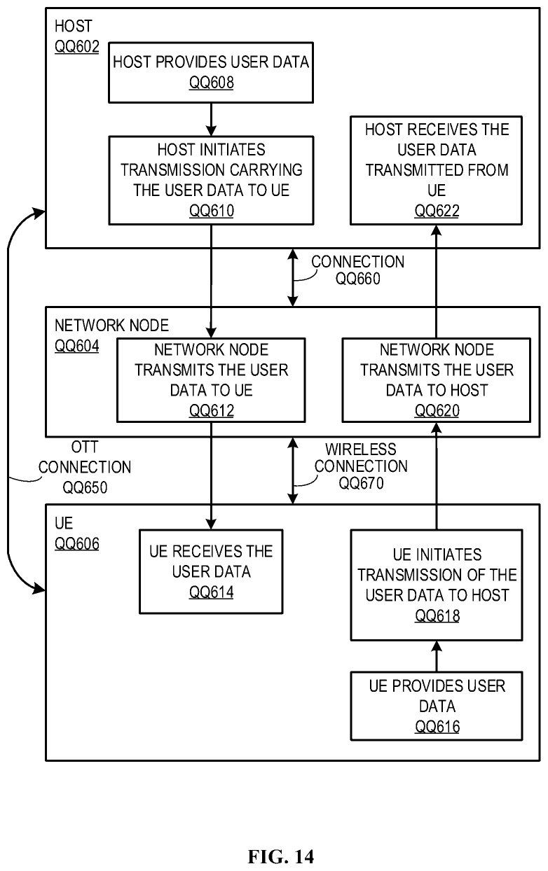

FIG. 14 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9), network node (such as network node QQ110a of FIG. 9), and host (such as host QQ116 of FIG. 9 and/or host QQ400 of FIG. 12) discussed in the preceding paragraphs will now be described with reference to FIG. 14.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, it can provide a coordinated way for NRF and NF consumer to perform NF discovery. In some embodiments herein, it can remove ambiguity on the behavior of NRF handling the request and NF consumer handling the search result when query parameters provided by NF consumer may not be supported by NRF. In some embodiments herein, it can avoid network traffic waste and avoid negative KPI due to rejection on service requests.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations related to the network node as described above to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the network node as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations related to the network node as described above to transmit the user data from the host to the UE.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations related to the network node as described above to receive the user data from the UE for the host.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of they of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the network node as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations related to the UE as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations related to the UE as described above to receive the user data from the host.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform any of the operations related to the UE as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs any of the operations related to the UE as described above to transmit the user data to the host.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a network function, NF, comprising:
sending a first NF discovery request comprising at least one query parameter to a first network repository function, NRF; and
receiving a first NF discovery response from the first NRF;
wherein the first NF discovery response comprises a search result and information indicating at least one ignored unsupported query parameter and/or at least one ignored supported query parameter in the at least one query parameter for the search result.

2. The method according to claim 1, further comprising:
obtaining information regarding one or more query parameters supported by the first NRF; and
determining one or more query parameters unsupported by the first NRF,
wherein the at least one query parameter includes at least one of the one or more query parameters supported by the first NRF and excludes the one or more query parameters unsupported by the first NRF.

3. (canceled)

4. The method according to claim 1, further comprising:
obtaining information regarding one or more query parameters supported by a second NRF; and
determining one or more query parameters unsupported by the second NRF,
wherein when the first NF discovery request includes a network identity of the second NRF, the at least one query parameter includes at least one of the one or more query parameters supported by the second NRF and excludes the one or more query parameters unsupported by the second NRF.

5. (canceled)

6. The method according to claim 4, wherein the first NRF comprises a visited NRF and the second NRF comprises a home NRF, or the first NRF comprises a home NRF and the second NRF comprises a visited NRF.

7. The method according to claim 1, further comprises:
determining whether the search result is useful or not based on the at least one ignored unsupported query parameters and/or the at least one ignored supported query parameter.

8-9. (canceled)

10. A method performed by a first NRF, comprising:
receiving a first NF discovery request comprising at least one query parameter from an NF; and
sending a first NF discovery response to the NF;
wherein the first NF discovery response comprises a search result and information indicating at least one ignored unsupported query parameter and/or at least one ignored supported query parameter in the at least one query parameter for the search result.

11. The method according to claim 10, wherein the at least one query parameter includes at least one of one or more query parameters supported by the first NRF and excludes one or more query parameters unsupported by the first NRF.

12. (canceled)

13. The method according to claim 10, wherein when the first NF discovery request includes a network identity of a second NRF, the at least one query parameter includes at least one of one or more query parameters supported by a second NRF and excludes one or more query parameters unsupported by the second NRF.

14-17. (canceled)

18. The method according to claim 10, wherein when the first NF discovery request includes a network identity of a second NRF, the method further comprises:
sending a fifth NF discovery request comprising the at least one query parameter to the second NRF; and
receiving a fifth NF discovery response from the second NRF.

19. The method according to claim 18, wherein the fifth NF discovery response comprises a search result and information indicating at least one ignored unsupported query parameter and/or at least one ignored supported query parameter in the at least one query parameter for the search result.

20. (canceled)

21. The method according to claim 10, wherein when the first NF discovery request excludes a network identity of a second NRF, the method further comprises at least one of:
determining a search result by ignoring at least one non-critical unsupported query parameter and/or at least one non-critical supported query parameter in the at least one query parameter, or
determining whether to reject or accept the first NF discovery request based on a criticality of an unsupported query parameter in the at least one query parameter, or
determining redirection information when a critical query parameter in the at least one query parameter is not supported.

22-28. (canceled)

29. An NF, comprising:
a processor; and
a memory coupled to the processor, said memory containing instructions executable by said processor, whereby said NF is operative to:
send a first NF discovery request comprising at least one query parameter to a first network repository function, NRF; and
receive a first NF discovery response from the first NRF;
wherein the first NF discovery response comprises a search result and information indicating at least one ignored unsupported query parameter and/or at least one ignored supported query parameter in the at least one query parameter for the search result.

30. (canceled)

31. A first NRF, comprising:
a processor; and
a memory coupled to the processor, said memory containing instructions executable by said processor, whereby said first NRF is operative to:
receive a first NF discovery request comprising at least one query parameter from an NF; and
send a first NF discovery response to the NF;
wherein the first NF discovery response comprises a search result and information indicating at least one ignored unsupported query parameter and/or at least one ignored supported query parameter in the at least one query parameter for the search result.

32-36. (canceled)

37. The method according to claim 13, wherein the first NRF comprises a visited NRF and the second NRF comprises a home NRF, or the first NRF comprises a home NRF and the second NRF comprises a visited NRF.
